(19) United States
(12) Patent Application Publication
(10) Pub. No.: US 2022/0043774 A1
(43) Pub. Date: Feb. 10, 2022

(54) SYSTEMS, METHODS, AND STORAGE MEDIA FOR TRANSFERRING DATA FILES

(71) Applicant: Spinnaker Support, LLC, Greenwood Village, CO (US)

(72) Inventors: Jeff Freers, Scarborough, ME (US); Ken Conz, Peoria, AZ (US)

(21) Appl. No.: 17/397,463

(22) Filed: Aug. 9, 2021

Related U.S. Application Data
(60) Provisional application No. 63/063,490, filed on Aug. 10, 2020.

(51) Int. Cl. G06F 16/176; G06F 16/17; G06F 16/16; G06F 16/178; G06F 16/14; G06F 16/13

(52) U.S. Cl. CPC G06F 16/176; G06F 16/1734; G06F 16/16; G06F 11/3457; G06F 16/148; G06F 16/13; G06F 16/178

(57) ABSTRACT

Systems, methods, and storage media for transferring data files are disclosed. Exemplary implementations may: provide a location for saving transferred data files; identify a data file operating system type; identify a database system associated with the transferred data files; enter credential information into a credential user interface provided by a data file vendor; navigate to a data file repository within a data file system operated by the data file vendor; identify a first data file directory structure for the data file repository within the data file system operated by the data file vendor; create a second data file directory structure on a customer data file system; and copy the data files from the first data file directory structure within the data file system operated by the data file vendor to the second data file directory structure in the customer data file system.

### CLAIM OF PRIORITY UNDER 35 U.S.C. § 119

The present Application for Patent claims priority to U.S. Provisional Application No. 63/002,921 entitled “Systems, Methods, and Storage Media for Transferring Data Files” filed Aug. 10, 2020, and assigned to the assignee hereof, which is hereby expressly incorporated by reference herein.

### FIELD OF THE DISCLOSURE

The present disclosure relates to systems, methods, and storage media for transferring data files.

### BACKGROUND

Numerous businesses/enterprises utilize enterprise software provided by software vendors. In some circumstances, however, a business or enterprise may decide to end their maintenance contract with a software vendor when, for instance, the software vendor is planning on terminating support for the enterprise software and the business or enterprise does not wish to migrate/utilize the new enterprise software offered to them by the vendor. In other cases, the business or enterprise may have previously purchased or licensed the enterprise software but may no longer have an active maintenance contract with the software vendor. In either case or in other cases, an enterprise may wish to ensure that they have all the software and documentation they are legally entitled to in their possession prior to the end of their maintenance contract with the software vendor.

### SUMMARY

In order to ensure an enterprise has all of the software and documentation for an enterprise software platform, systems, methods and storage media were developed for transferring data files associated with the enterprise software. The following disclosure presents a summary relating to one or more aspects and/or embodiments disclosed herein. The summary should not be considered an extensive overview relating to all contemplated aspects and/or embodiments, nor should the summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

For the purpose of this disclosure, the term “software vendor” or “data file vendor” may refer to a software or business technology platform, such as SAP SE of Walldorf, Germany. SAP SE is a software corporation that develops enterprise software to manage business operations and customer relations. It should be noted that, other software or business technology platforms, besides SAP SE, may be contemplated as software vendors or data file vendors in different embodiments. Further, as used herein, the term “credential information” may include one or more of a username, an email address, a password, biometrics information (e.g., fingerprint, iris or retina scan, voice recognition, facial recognition), multi-factor authentication (MFA) information, or any other applicable information that can be used to confirm a user's identity. In some embodiments, the term “data file repository” may refer to a storage space, such as a database infrastructure, where data (e.g., files, documents, executable files or programs, etc.) may be collected, managed, and stored. As used herein, the term “user” may refer to any one of a client user or a support side user.

One aspect of the present disclosure relates to a system configured for transferring data files. The system may include one or more hardware processors configured by machine-readable instructions. The processor(s) may be configured to provide a location for saving transferred data files. The processor(s) may be configured to identify a data file operating system type. The processor(s) may be configured to identify a database system associated with the transferred data files. The processor(s) may be configured to enter credential information into a credential user interface provided by a data file vendor. The processor(s) may be configured to navigate to a data file repository within a data file system operated by the data file vendor. The processor(s) may be configured to identify a first data file directory structure for the data file repository within the data file system operated by the data file vendor. The processor(s) may be configured to create a second data file directory structure on a customer data file system. The processor(s) may be configured to copy the data files from the first data file directory structure within the data file system operated by the data file vendor to the second data file directory structure in the customer data file system.

Another aspect of the present disclosure relates to a method for transferring data files. The method may include providing a location for saving transferred data files. The method may include identifying a data file operating system type. The method may include identifying a database system associated with the transferred data files. The method may include entering credential information into a credential user interface provided by a data file vendor. The method may include navigating to a data file repository within a data file system operated by the data file vendor. The method may include identifying a first data file directory structure for the data file repository within the data file system operated by the data file vendor. The method may include creating a second data file directory structure on a customer data file system. The method may include copying the data files from the first data file directory structure within the data file system operated by the data file vendor to the second data file directory structure in the customer data file system.

Yet another aspect of the present disclosure relates to a non-transient computer-readable storage medium having instructions embodied thereon, the instructions being executable by one or more processors to perform a method for transferring data files. The method may include providing a location for saving transferred data files. The method may include identifying a data file operating system type. The method may include identifying a database system associated with the transferred data files. The method may include entering credential information into a credential user interface provided by a data file vendor. The method may include navigating to a data file repository within a data file system operated by the data file vendor. The method may include identifying a first data file directory structure for the data file repository within the data file system operated by the data file vendor. The method may include creating a second data file directory structure on a customer data file system. The method may include copying the data files from the first data file directory structure within the data file system operated by the data file vendor to the second data file directory structure in the customer data file system.

These and other features and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured for transferring data files, in accordance with one or more implementations.

FIG. 2 illustrates a method for transferring data files, in accordance with one or more implementations.

FIG. 3 illustrates an example of a communications network for transferring data files, in accordance with one or more implementations.

FIG. 4A illustrates an example of a communications network for transferring data files, in accordance with one or more implementations.

FIG. 4B illustrates a detailed view of the communications network in FIG. 4A, in accordance with one or more implementations.

FIG. 5 illustrates a block diagram of a computing system, according to an embodiment of the disclosure.

FIG. 6 illustrates a swim diagram of a method for transferring data files, according to an embodiment of the disclosure.

FIG. 7 illustrates an example of a user interface (UI) for transferring data files, in accordance with one or more implementations.

FIG. 8 illustrates another example of a UI for transferring data files, in accordance with one or more implementations.

FIG. 9 illustrates another example of a UI for transferring data files, in accordance with one or more implementations.

FIG. 10 illustrates another example of a UI for transferring data files, in accordance with one or more implementations.

FIG. 11 illustrates still another example of a UI for transferring data files, in accordance with one or more implementations.

### DETAILED DESCRIPTION

Enterprise software may refer to software products or business-oriented tools that are used to satisfy the needs of an organization or business, rather than individual users. Some non-limiting examples of enterprise software includes software utilized for one or more of business management, enterprise resource planning (ERP), IT service management, human resource (HR) management, business process management, and financial accounting. Other types of enterprise software, such as online shopping and online payment processing software, customer relationship management (CRM) software, for instance, SALESFORCE provided by SALESFORCE, INC., of San Francisco, Calif., and/or business intelligence software are contemplated in different embodiments. SAP SE of Walldorf, Germany is one of the most prominent providers of enterprise software. Their enterprise software is used by numerous businesses around the world to manage business operations and/or customer relations. It should be noted that, the system of the present disclosure may be compatible with other providers of enterprise software, besides the providers described herein, in different embodiments.

In some cases, a business or enterprise may utilize an enterprise software provided by a software vendor. In some circumstances, however, the business or enterprise may decide to end their maintenance contract with the software vendor, for instance, if the software vendor is planning on terminating support for the enterprise software and the business or enterprise does not wish to migrate/utilize a new enterprise software product. In other cases, the business or enterprise may have previously purchased or licensed the enterprise software but may no longer have an active maintenance contract with the software vendor. In either case, the customers may like to ensure that they have all the software and documentation they are entitled to in their possession prior to the end of their maintenance contract with the software vendor. In some circumstances, a business may be unsure of the software and documentation (e.g., software versions or releases, updates, if any, software fixes, to name a few non-limiting examples) they have in their possession, have paid for but have neither downloaded nor installed/implemented, etc. In some cases, such scenarios may arise due to the significant passage of time since the enterprise software was purchased/licensed and/or changes in the organization (e.g., new IT personnel, new users, different management, etc.).

In some cases, for instance, with SAP customers, the amount of storage space required to maintain their software may be significant (e.g., on the order of 100s of gigabytes or even terabytes). A common challenge faced by companies in securing their enterprise software data is the proper capturing and management of the data (e.g., software updates, software fixes or patches, etc.) specific to their environments without capturing unnecessary data (e.g., data related to unrelated software). As used herein, the term “environment” may be used to refer to an operating system (e.g., WINDOWS provided by MICROSOFT, INC., of Redmond, Wash.; macOS provided by APPLE INC., of Cupertino, Calif., etc.), a software platform, and/or a software framework (e.g., a reusable software system in which software, providing generic functionality, can be selectively changed by additional user-written code, thus providing application-specific software). In some cases, the amount of time needed to research and properly organize the data that needs to be captured and catalogued for future use may take several weeks, or even months, since it involves reviewing each individual software application package and its supporting documentation. Addressing these tasks for an entire software ecosystem in an organization or enterprise may involve the effort of multiple resources in the organization, which is not only costly, but also time intensive. Since businesses are not only resource constrained, but also time constrained, it may be difficult for businesses to complete these activities by a contract end date. Specifically, such activities may comprise identifying, selecting, downloading, and cataloging the data files for one or more software applications. In some cases, this situation may be compounded when an enterprise or business utilizes multiple enterprise (e.g., SAP) application software platforms. Further, the likelihood of missing one or more files, accidentally downloading an incorrect or incompatible file, etc., may be substantially higher when a human operator is tasked with reviewing and analyzing thousands of files. For example, a typical customer (i.e., business or enterprise) may need to download hundreds of thousands of individual files encompassing several terabytes of storage space. With these vast troves of data comes the need to adequately manage the storage of said data, for instance, if the data needs to be accessed and applied to a software application at a future date. In some cases, it is not easily apparent what the application/version of a file is by simply looking at the file name due to the file naming conventions utilized by the software vendor. In some examples, a customer or business may not utilize the downloaded data for several months or years. In such cases, an enterprise may utilize a significant amount of time and/or resources to identify what software application versions, updates, fixes or patches, etc., are in its possession. Thus, capturing and managing data (e.g., for the right application, operating system, etc.) is a time consumptive and often-times, costly, activity.

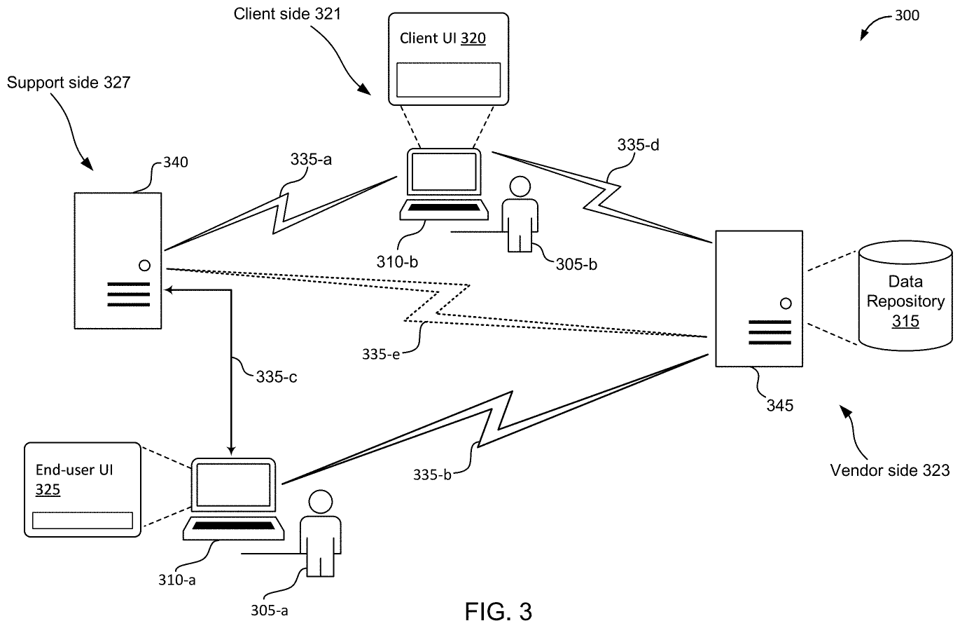

As used herein, the term “data” may broadly be divided into two categories. For example, a first category of data may comprise software (e.g., enterprise software). In some examples, companies or enterprises may run small (e.g., 10, 50, 100 users) or large SAP application-level software packages (e.g., hundreds to thousands of users). Software may comprise package enhancements (e.g., updates) to existing software or application versions, optional patches related to the application (e.g., to address security issues or weaknesses in the software, such as security vulnerabilities that may result in an information leak or unauthorized access, sensitive data exposure, etc., or to add functionality or new features to the software, such as an updated user interface (UI), to name two non-limiting examples), or even a database. An enhancement may also comprise an improvement to a program that may provide additional functionality. One such improvement may comprise a change to a word processing program enabling a user to review the grammar within a document across multiple languages, as compared to the program only enabling a grammar check in the English language prior to the enhancement. Additionally, or alternatively, software may also encompass releases of the software/application beyond the version that the customer or enterprise may be currently running and/or onboarding patches and enhancements for those versions as well. In some cases, the second category of data may comprise individual fixes for one or more software programs/applications. A “fix” may comprise a change to a software program/application that resolves incorrect behavior in a program. For example, a word processing program might crash when a user has too many open documents. The “fix” is that the word document program is changed to stop crashing regardless of how many documents are open. In some cases, fixes may be referred to as patches, since both fixes and patches may be used to correct one or more defects/issues in software programs/applications. Patches or fixes may refer to software updates comprising computer-readable code inserted (or patched) into the code of an executable program. Typically, patches or fixes are installed into an existing software program, and serve as a temporary remedy (i.e., fix) between full releases of a software package. In some examples, fixes may be used to fix (or repair) bugs in the software programs/applications. Some bugs may be relatively minor (e.g., cause the program to incorrectly render an output or improperly format a message, such as an error message). In other cases, bugs may be more significant, for instance, impacting the ability of a user or employee to log in to a company's network. Other types of bugs (e.g., that cause a software program to overwrite the storage capacity of the program, causing it to “crash”, commonly referred to as buffer overflow) may be addressed using fixes or patches, in different embodiments. While not necessary, the individual fixes may be downloaded from the software vendor's website, server, data center, or any other applicable network connected system or device. For example, a software vendor (e.g., SAP, etc.) may maintain a data repository or server (e.g., shown as server 345 in FIG. 3, also referred to as vendor side server 345) where data specific to one or more applications, software products, programs, etc., offered by the software vendor may be stored. This data may be accessible for download from the software vendor's website. In some cases, the software vendor may have developed one or more individual fixes to address specific problems (e.g., run-time errors, software crashes, infinite loops, inefficient memory management, etc.) faced by customers/users of the software. In some cases, these problems may be related to the current version of the software package, or alternatively, a previous or older version of the software package running on a database or operating system used by the customer. These fixes may be identified by the software vendor (e.g., SAP SE) as notes. In some examples, the number of notes may range, for instance, from a few hundred to several thousand for an application. In some cases, the number of notes may depend on, for instance, the last time the customer installed an enhancement or patch to their environment. Generally, a software vendor allows notes to be downloaded individually (e.g., one at a time). However, when a client or enterprise is faced with hundreds or even thousands of notes, it may be impractical, if not unfeasible, for the process to be completed and managed by a human operator within a reasonable period.

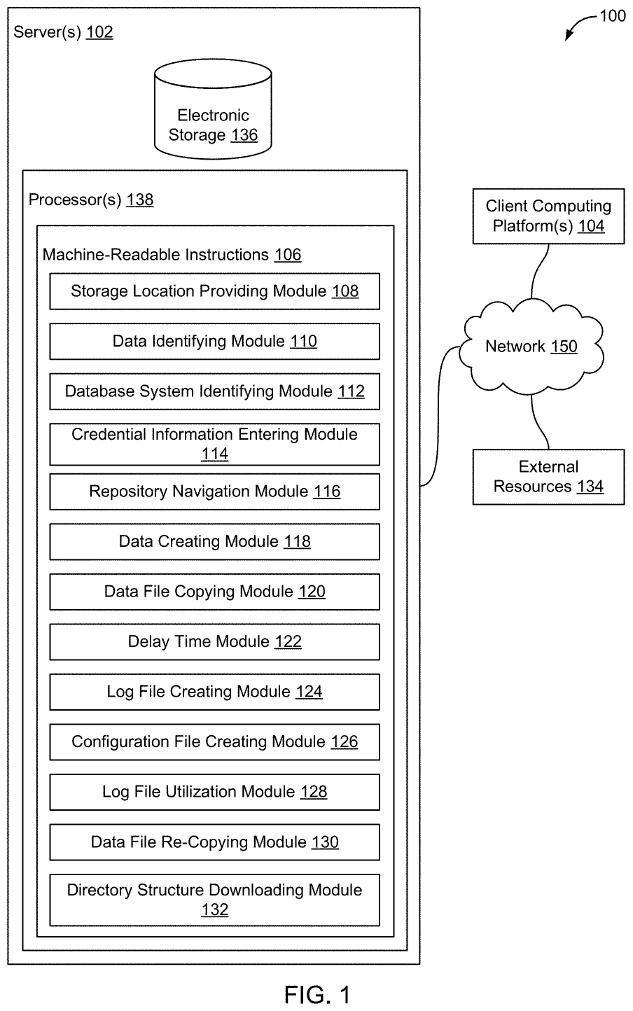

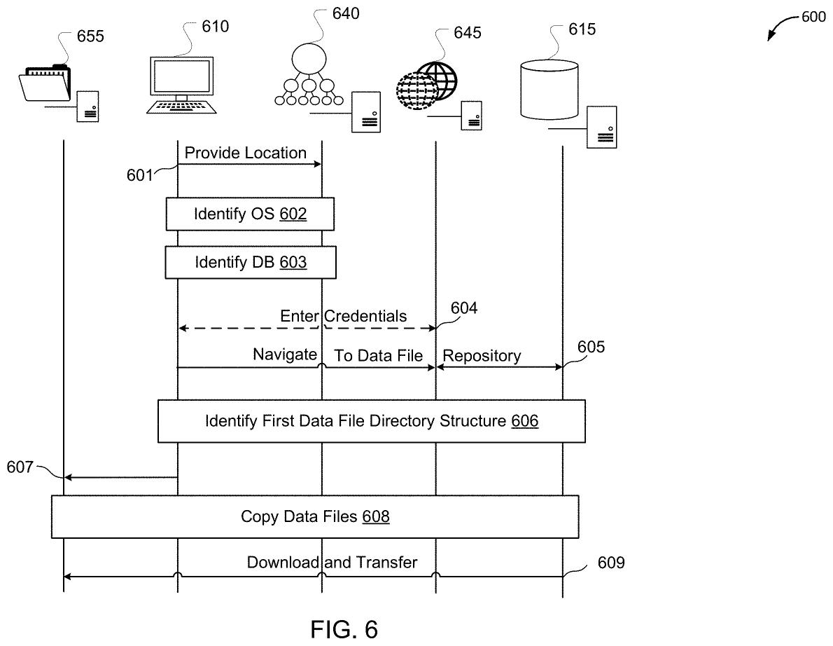

According to aspects of the present disclosure, a system for capturing data files (e.g., software) from a software vendor's portal (e.g., website, data repository, server, etc.) and transferring said data files to a customer's hardware is provided. In one non-limiting example, the software vendor's portal may comprise an SAP support portal. Other types of software vendor portals known in the art are also contemplated in different embodiments. In some cases, the system (e.g., system 100 in FIG. 1, server 340 in FIG. 3, server 640 in FIG. 6) of the present disclosure may be embodied in hardware, software, or a combination thereof. The system may comprise an application or software program hosted and executed on a support side server (e.g., server 340 on support side 327 in FIG. 3), where the application or software program may facilitate in minimizing the time required to identify, select, download, and/or catalog data for one or more applications/enterprise software products utilized by a client. In some aspects, the system of the present disclosure may serve to minimize the manual selection and downloading of data from a software vendor's data repository (e.g., shown as server 345 comprising data repository 315 on vendor side 323 in FIG. 3). In some embodiments, the system (e.g., system 100 or server 340) may provide a user interface (e.g., end-user UI 325 in FIG. 3) that may allow an end-user (e.g., an administrator, IT or tech support member) to setup the criteria for enabling the system (e.g., system 100) to capture the relevant data for a customer. In some cases, the end-user UI 325 and/or the software/program hosted and executed on the server 340 may be written using a computer language, such as Python, although other programming languages are also contemplated in different embodiments. In some cases, one or more data files may be downloaded and installed into a data file directory structure (also referred to as directory) on the customer's local machine (e.g., a desktop, laptop) or data file system, cloud machine, or enterprise network.

FIG. 1 illustrates a system 100 configured for transferring data files, in accordance with one or more implementations. In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Machine-readable instructions 106 may include one or more instruction modules. The instruction modules may include computer program modules. The instruction modules may include one or more of a location providing module 108, data identifying module 110, database system identifying module 112, credential information entering module 114, data file repository navigation module 116, data creating module 118, data file copying module 120, delay time identifying module 122, log file creating module 124, configuration file creating module 126, log file utilization module 128, data file re-copying module 130, data file directory structure downloading module 132, and/or other instruction modules.

Location providing module 108 may be configured to provide a location for saving transferred data files. Some non-limiting examples of a location may include a network location (e.g., File Transfer Protocol (FTP) address, network address, such as an Internet Protocol (IP) address, a Media Access Control (MAC) address), a network drive (e.g., using New Technology File System or NTFS developed by MICROSOFT, INC., of Redmond, Wash.), a folder in the network drive, a data file directory structure or directory (e.g., a file system cataloging structure that comprises a structured list of documents and/or folders stored on a computer) on the customer's local or cloud machine or network, or any other applicable location.

Data identifying module 110 may be configured to identify a data file operating system type. Some non-limiting examples of a data file operating system may include the WINDOWS operating system provided by MICROSOFT, INC., of Redmond, Wash., macOS provided by APPLE INC., of Cupertino, Calif., and LINUX operating system. Other data file operating systems known in the art are contemplated in different embodiments. In some embodiments, the data file operating system may include an operating system specifically designed to run on mobile devices or tablets, such as ANDROID provided by ALPHABET, INC., of Mountain View, Calif.

Data identifying module 110 may be configured to identify a first data file directory structure for the data file repository (e.g., data repository 315 in FIG. 3) within the data file system (e.g., installed on server 345 on vendor side 323 in FIG. 3) operated by the data file vendor. The first data file directory structure may comprise a link identifying a group of files. Other types of data file directory structures are contemplated in different embodiments, and the examples listed are not intended to be limiting.

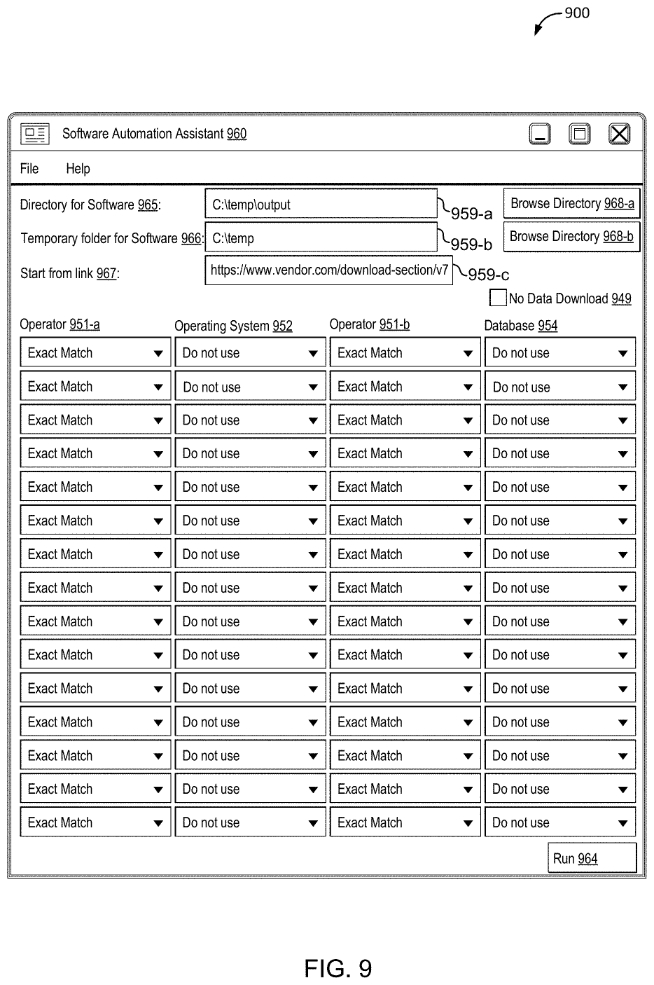

Database system identifying module 112 may be configured to identify a database system (e.g., shown as database 954 in FIG. 9) associated with the transferred data files. In some cases, the database system may be the same as or substantially similar to the data repository (e.g., data repository 315 in FIG. 3). Alternatively, the data repository 315 may be linked or associated with one or more database systems. For example, the data repository 315 may comprise one or more databases, where each database is electronically, communicatively, or logically coupled to one of the one or more database systems. Some non-limiting examples of database systems include MySQL, Microsoft SQL Server, and Oracle Database. In some cases, a database system may also be referred to as a database management system (DBMS), where the DBMS serves as an interface between a database and its end users or programs, allowing users to retrieve, update (if authorized), and/or manage how the information or data is organized. In this example, the database system associated with the transferred data files (e.g., software package; updates, fixes, and/or patches to software package(s), notes, etc.) may be utilized to retrieve or access information pertaining to how the data files are stored and organized on the vendor side (e.g., vendor side 323 in FIG. 3) systems, where the vendor side systems may include at least the server 345 and the data repository 315.

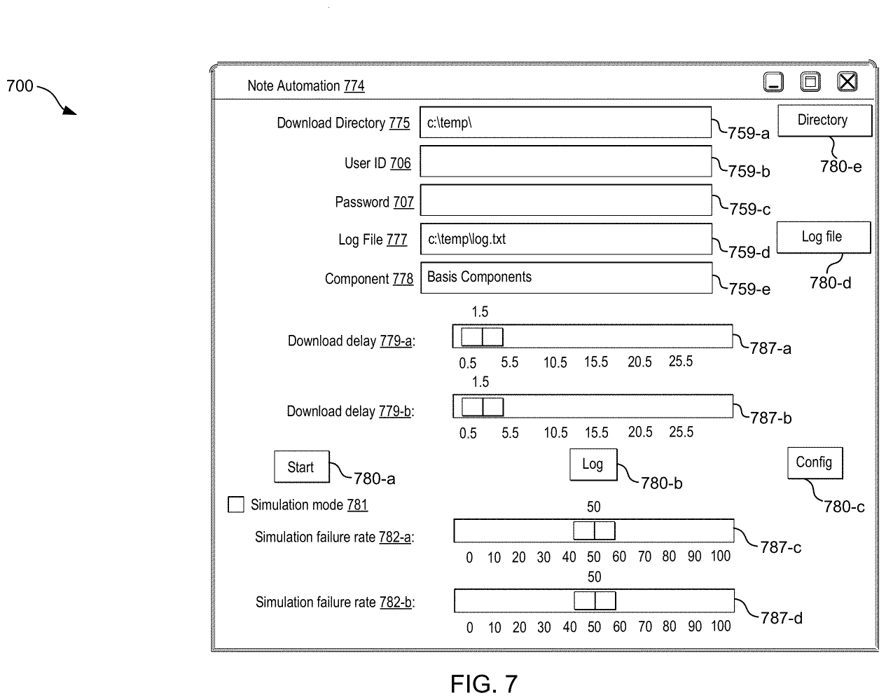

Credential information entering module 114 may be configured to enter credential information (e.g., user ID 706 and password 707 in FIG. 7) into a credential user interface provided by a data file vendor. Some non-limiting examples of credential information may include a username, an email address, a password, and a unique identifier or number (e.g., for an employee, for the employer or client). In some embodiments, the data file vendor (e.g., SAP) may provide customers or clients with a user interface or portal (e.g., a website, a mobile application) that allows the customer/client to view information related to software applications/products provided by the vendor, purchase or license software applications/products, download software updates or fixes to software applications already purchased by the customer, terminate maintenance contract(s) for one or more software applications/products previously licensed by the customer, and receive technical support (e.g., live support from a human operator, Artificial Intelligence (AI)-based support), to name a few non-limiting examples.

Data file repository navigation module 116 may be configured to navigate to a data file repository (e.g., shown as data repository 315 in FIG. 3) within a data file system (e.g., installed on or associated with server 345) operated by the data file vendor. In some cases, the data repository may be embodied in hardware, software, or a combination thereof.

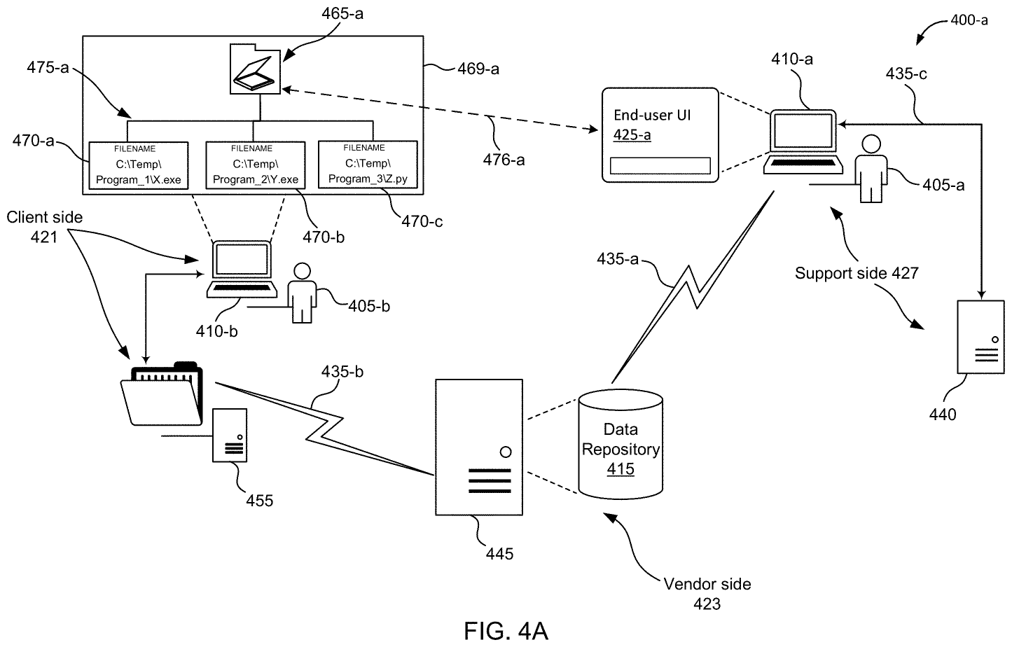

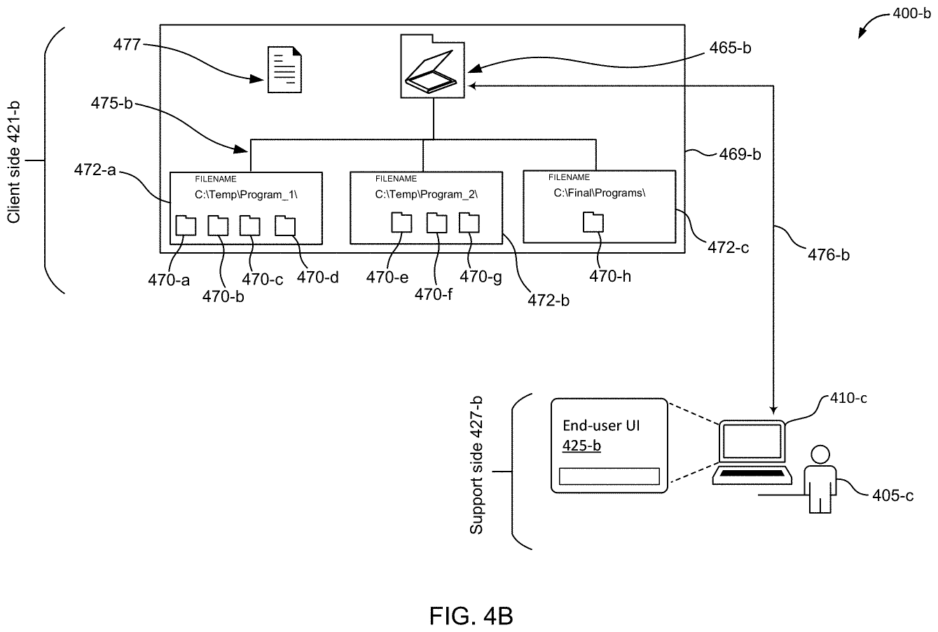

Data creating module 118 may be configured to create a second data file directory structure (e.g., shown as data file directory structure 475-a in FIG. 4A) on a customer data file system (e.g., shown as customer data file system 469-a in FIG. 4A). In some examples, the data file directory structure may comprise information related to the files, folders, etc., related to a directory (e.g., shown as directory 465-a in FIG. 4A). In some cases, the directory 465-a may be a file or folder that contains information about one or more other files or folders contained within it, such as data files 470-a, 470-b, and/or 470-c. In some cases, the information may include one or more of a file name (e.g., ‘X.exe’ for data file 470-a), file type (e.g., data files 470-a and 470-b are executables having the ‘.exe’ extension, data file 470-c is a Python programming language file having the ‘.py’ extension), file location (e.g., data file 470-a is in a folder called ‘Program 1’, where the ‘Program 1’ folder is within another folder called ‘Temp’, and where the ‘Temp’ folder is located on ‘C’ drive on the customer's local machine, i.e., user device 410-b), the mode, such as read-only, read-write, etc., in which the file can be accessed, to name a few non-limiting examples. By way of non-limiting example, the data files (e.g., data files 470-a-c) may include at least one of enterprise application software, patches for the enterprise application software, and support documentation for the enterprise application software and/or the patches. The data files may be adapted for use with an operating system (e.g., LINUX) related to the customer data file system (e.g., UNIX/LINUX file system).

Data file copying module 120 may be configured to copy the data files from the first data file directory structure (e.g., data file directory structure associated with data repository 415 and/or server 445 on vendor side 423 in FIG. 4) within the data file system (i.e., installed or associated with server 445) operated by the data file vendor to the second data file directory structure (e.g., data file directory structure 475-a in FIG. 4) in the customer data file system (e.g., shown as customer data file system 469-a installed on user device 410-b and associated with file server 455 on client side 421). In some embodiments, the data file copying module 120 may be configured to instruct vendor side server (i.e., server 445) to upload the one or more data files from the first data file directory structure to the second data file directory structure, for instance, over communication link 435-b. In some cases, the data files may first be copied to a file server operated by the client/enterprise, shown as file server 455 on client side 421. In some cases, the file server 455 may be an example of a central server in the client enterprise network that provides file system(s) or at least portions of a file system to connected clients (e.g., user devices, such as user device 410-b). In some examples, the file server 455 may offer users (e.g., shown as user 405-b) a central storage place for files, documents, etc., on internal data media (e.g., hard-disk). The file server 455 may be responsible for the central storage and management of data files so that other user devices, computers, etc., on the client side 421 network can access them. In some embodiments, the user device 410-b may comprise a computing device that is one or more of logically, electronically, and communicatively coupled to the client-side server (e.g., server 455). In some examples, after the one or more data files are copied to the file server 455, they may be transferred and copied to the user device 410-b. In some aspects, the file server 455 may serve as a backup data source, for example, if the user device 410-b becomes inoperable. Additionally, or alternatively, the file server 455 may allow other user devices connected to the client side 421 network, for instance, user devices associated with one or more other employees of the enterprise, to receive the one or more data files from the file server 455 instead of from the server 445 on the vendor side 423. It should be noted that, the file server 455 may be optional in some embodiments. In some cases, for instance, when there is no file server 455 on the client side 421, the data file copying module 120 may be configured to directly copy the data files from the first data file directory structure (e.g., data file directory structure associated with data repository 415) within the data file system (i.e., associated with server 445) operated by the data file vendor to the second data file directory structure (e.g., data file directory structure 475-a in FIG. 4) in the customer data file system (e.g., customer data file system 469).

Delay time identifying module 122 may be configured to identify one or more delay times (e.g., 1 second, 10 seconds, 50 seconds, 3 minutes, etc.) for copying at least one data file type. Copying the data files from the first data file directory structure within the data file system operated by the data file vendor to the second data file directory structure in the customer data file system may include identifying one or more of the at least one data file type. Some non-limiting examples of data file types may include PDF and SAP/CAR. In some cases, the one or more delay times (e.g., download delay 779-a, download delay 779-b in FIG. 7) may be specified by a support side user (e.g., user 405-a in FIG. 4A) through a UI (e.g., end-user UI 425-a in FIG. 4A, UI 700 in FIG. 7).

Log file creating module 124 may be configured to create a log file (e.g., shown as log file 477 in FIG. 4B). By way of non-limiting example, the log file may include one or more of information received from the user (e.g., shown as user 405-a on support side 427), requests sent to the data file vendor, and response messages received from the data file vendor. In some embodiments, at least one of the response messages received from the data file vendor includes names and/or locations of the data files (i.e., names and/or locations of the data files within data repository 415 on vendor side 423), and error messages. The information received from the user 405-a may include at least the location (e.g., in ‘C’ drive in user device 410-b, under folder ‘Temp’, and under sub-folder ‘Program 1’ for data file 470-a; in ‘D’ drive in user device 410-b, under folder ‘Temp’, under sub-folder ‘Program 2’ for data file 470-b) for saving transferred data files.

In some embodiments, the system 100 may be configured to simulate a failure rate prior to copying the data files from the first data file directory structure to the second data file directory structure. In some embodiments, a support side user (e.g., user 405-a on support side 427) may indicate one or more simulation failure rates (e.g., simulation failure rate 782-a, simulation failure rate 782-b) using a user interface (e.g., UI 700).

Configuration file creating module 126 may be configured to create a configuration file. The configuration file may include criteria for copying the data files from the first data file directory structure to the second data file directory structure, further described below in relation to FIG. 7.

Log file utilization module 128 may be configured to utilize the log file and second data file directory structure to verify the second data file directory includes each of the names of the data files. Additionally, or alternatively, the log file utilization module 128 may be configured to display the names of one or more data files not downloaded to the second data file directory structure.

Data file re-copying module 130 may be configured to re-copy the data files from the first data file directory structure within the data file system operated by the data file vendor to the second data file directory structure in the customer data file system. The re-copying of the data files may include copying the one or more data files not downloaded to the second data file directory structure. Utilizing the log file and second data file directory structure to verify the second data file directory structure may comprise identifying each of the names of the data files and simulating the copying of the data files from the first data file directory structure to the second data file directory structure, for instance, to determine the names of one or more data files not downloaded to the second data file directory structure. In some cases, reconciliation or reconciling may refer to the process of verifying the second data file structure to determine the data files not downloaded to the second data file directory structure and re-copying the data files from the first data file directory structure to the second data file directory structure.

Data file directory structure downloading module 132 may be configured to manually download (e.g., based on user input) at least a portion of the one or more data files, identified in a log file or other file, not downloaded to the second data file directory structure.

In some implementations, the group of files (i.e., data files) may comprise files for a particular application and may further comprise a particular application version of the data files (e.g., version 7 of an enterprise software, patches or fixes for version 7, etc.). In some implementations, the second data file directory structure (e.g., data file directory structure 475-a in FIG. 4A) may include a temporary file folder (e.g., ‘Temp’ folder in C-drive) and a final file directory or folder. In some implementations, copying the data files from the first data file directory structure to the second data file directory structure may include, verifying accuracy of the second data file directory structure, copying the data files to the temporary data file folder, and moving the data files from the temporary data file folder to the final file directory or folder in the second data file directory structure. In some implementations, the at least one data file type may include a Portable Document Format (PDF) developed by Adobe Inc., of San Jose, Calif. and an SAR/CAR file type (also referred to as SAPCAR, which is a compress utility or compression program used by SAP to compress/decompress files). In some implementations, the data files may be related to a specific operating system, such as WINDOWS, LINUX, etc.

In some implementations, a customer key, an enterprise component, and customer contact information may be utilized to identify the customer and the enterprise component type, as further described below in relation to FIGS. 7-11. In some cases, the enterprise component type may also be referred to as the software component type (e.g., type of SAP component). Some implementations may also comprise a failure rate which may include a probability of a copying failure which may, for example, comprise a failure rate for at least one of a PDF file type and a SAR/CAR file type (also known as SAPCAR).

Setting a failure rate enables a user to verify the system 100 can properly log the failures across various rates. For example, setting a failure rate of 1% informs the system 100 that one out of every 100 files has failed to download/transfer properly while setting a failure rate of 95% informs the system that 95 out of every 100 files has failed to download/transfer properly. With such a feature, a user is able to review the log file for these simulated failures to ensure the log file contains the proper information in the event that an actual failure occurs. When actual failures occur, the user will review the log file and adjust the program settings to reduce/remove the failures. One adjustment that can be made to reduce failures is to adjust the speed of the program. For example, a failure may occur because the website is responding slowly. When a website is operating slowly, the system 100 will wait for a set amount of time for the download to occur, and if the download does not initiate during the set amount of time, the system will log the failure and move on to the next step in the process. Upon reviewing the log file, the user may see that there is a need to slow the speed that the program is processing files to prevent such failures. Upon adjusting the processing speed of the system, 100, the system 100 program will wait longer for the file to download on the next run of the system 100.

Server(s) 102, client computing platform(s) 104, and/or external resources 134 may be operatively linked via one or more electronic communication links. Electronic communication links may be established, at least in part, via a network 150 such as the Internet and/or other networks. It will be appreciated that this is not intended to be limiting, and that the scope of this disclosure includes implementations in which server(s) 102, client computing platform(s) 104, and/or external resources 134 may be operatively linked via some other communication media.

A given client computing platform 104 may include one or more processors configured to execute computer program modules. The computer program modules may be configured to enable an expert or user associated with the given client computing platform 104 to interface with system 100 and/or external resources 134, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 134 may include sources of information outside of system 100, external entities participating with system 100, and/or other resources. In some implementations, some or all of the functionality attributed herein to external resources 134 may be provided by resources included in system 100.

Server(s) 102 may include electronic storage 136, one or more processors 138, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 136 may comprise non-transitory storage media that electronically stores information. The electronic storage media of electronic storage 136 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 136 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 136 may include one or more virtual storage resources (e.g., cloud storage, a virtual private network, and/or other virtual storage resources). Electronic storage 136 may store software algorithms, information determined by processor(s) 138, information received from server(s) 102, information received from client computing platform(s) 104, and/or other information that enables server(s) 102 to function as described herein.

Processor(s) 138 may be configured to provide information processing capabilities in server(s) 102. As such, processor(s) 138 may include one or more of a digital processor, an analog processor, a digital circuit designed to process information, an analog circuit designed to process information, a state machine, and/or other mechanisms for electronically processing information. Although processor(s) 138 is shown in FIG. 1 as a single entity, this is for illustrative purposes only. In some implementations, processor(s) 138 may include a plurality of processing units. These processing units may be physically located within the same device, or processor(s) 138 may represent processing functionality of a plurality of devices operating in coordination. Processor(s) 138 may be configured to execute modules 108, 110, 112, 114, 116, 118, 120, 122, 124, 126, 128, 130, and/or 132, and/or other modules. Processor(s) 138 may be configured to execute modules 108, 110, 112, 114, 116, 118, 120, 122, 124, 126, 128, 130, and/or 132, and/or other modules by software; hardware; firmware; some combination of software, hardware, and/or firmware; and/or other mechanisms for configuring processing capabilities on processor(s) 138. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, 118, 120, 122, 124, 126, 128, 130, and/or 132 are illustrated in FIG. 1 as being implemented within a single processing unit, in implementations in which processor(s) 138 includes multiple processing units, one or more of modules 108, 110, 112, 114, 116, 118, 120, 122, 124, 126, 128, 130, and/or 132 may be implemented remotely from the other modules. The description of the functionality provided by the different modules 108, 110, 112, 114, 116, 118, 120, 122, 124, 126, 128, 130, and/or 132 described below is for illustrative purposes, and is not intended to be limiting, as any of modules 108, 110, 112, 114, 116, 118, 120, 122, 124, 126, 128, 130, and/or 132 may provide more or less functionality than is described. For example, one or more of modules 108, 110, 112, 114, 116, 118, 120, 122, 124, 126, 128, 130, and/or 132 may be eliminated, and some or all of its functionality may be provided by other ones of modules 108, 110, 112, 114, 116, 118, 120, 122, 124, 126, 128, 130, and/or 132. As another example, processor(s) 138 may be configured to execute one or more additional modules that may perform some or all of the functionality attributed below to one of modules 108, 110, 112, 114, 116, 118, 120, 122, 124, 126, 128, 130, and/or 132.

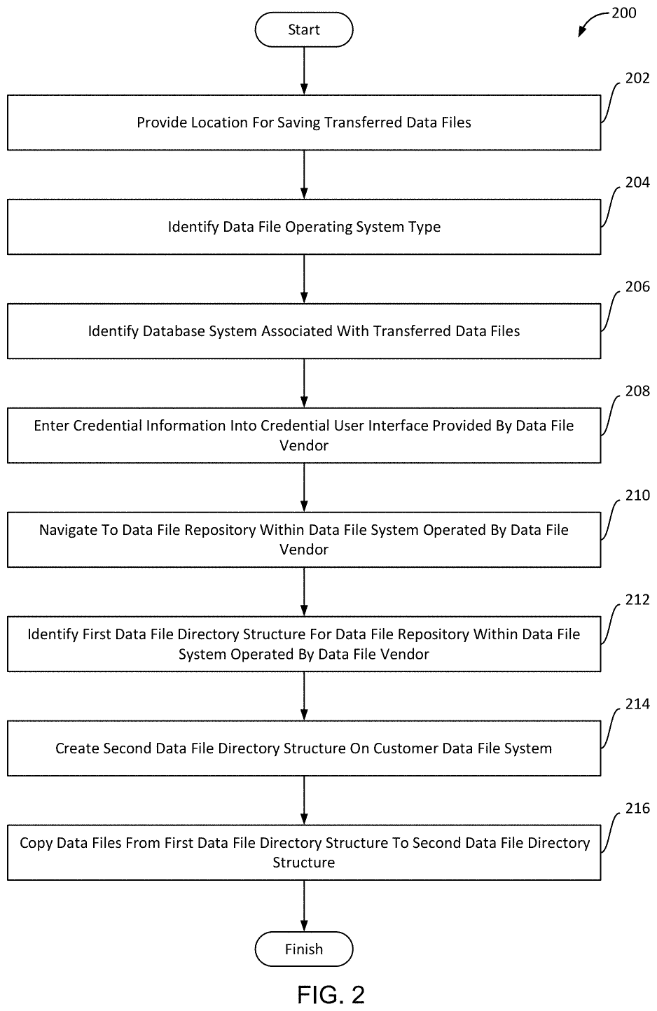

FIG. 2 illustrates a method 200 for transferring data files, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include providing a location for saving transferred data files. Operation 202 may be performed by one or more hardware processors configured by machine-readable instructions including a module that is the same as or similar to location providing module 108, in accordance with one or more implementations.

An operation 204 may include identifying a data file operating system type. Operation 204 may be performed by one or more hardware processors configured by machine-readable instructions including a module that is the same as or similar to data identifying module 110, in accordance with one or more implementations.

An operation 206 may include identifying a database system associated with the transferred data files. Operation 206 may be performed by one or more hardware processors configured by machine-readable instructions including a module that is the same as or similar to database system identifying module 112, in accordance with one or more implementations.

An operation 208 may include entering credential information (e.g., a user ID, a password, or any other applicable unique identifier) into a credential user interface provided by a data file vendor (e.g., an enterprise software vendor, such as SAP). Operation 208 may be performed by one or more hardware processors configured by machine-readable instructions including a module that is the same as or similar to credential information entering module 114, in accordance with one or more implementations.

An operation 210 may include navigating to a data file repository (e.g., data file repository 415 in FIG. 4A, also referred to as data repository 415) within a data file system operated by the data file vendor. In some cases, the data file system may be associated or installed on a server (e.g., server 445 on vendor side 423 in FIG. 4A). Operation 210 may be performed by one or more hardware processors configured by machine-readable instructions including a module that is the same as or similar to data file repository navigation module 116, in accordance with one or more implementations.

An operation 212 may include identifying a first data file directory structure for the data file repository within the data file system operated by the data file vendor. Operation 212 may be performed by one or more hardware processors configured by machine-readable instructions including a module that is the same as or similar to data identifying module 110, in accordance with one or more implementations.

An operation 214 may include creating a second data file directory structure on a customer data file system (e.g., customer or client data file system 469-a in FIG. 4A). In some cases, creating the second data file directory structure (e.g., data file directory structure 475-a in FIG. 4A) may be based at least in part on identifying the first data file directory structure. For instance, the second data file directory structure may be similar or substantially similar to the first data file directory structure. Operation 214 may be performed by one or more hardware processors configured by machine-readable instructions including a module that is the same as or similar to data creating module 118, in accordance with one or more implementations.

An operation 216 may include copying the data files from the first data file directory structure within the data file system operated by the data file vendor to the second data file directory structure in the customer data file system. Operation 216 may be performed by one or more hardware processors configured by machine-readable instructions including a module that is the same as or similar to data file copying module 120, in accordance with one or more implementations.

FIG. 3 illustrates an example of a communications network 300 comprising one or more servers (e.g., server 340 on support side 327, server 345 on vendor side 323), one or more user devices (e.g., user device 310-a on support side 327, user device 310-b on client or customer side 321), and a data repository 315 hosted or stored on server 345. In some examples, a data file system operated by the data file vendor may comprise one or more of the server 345 and the data repository 315. Further, the data repository 315 may be associated with a first data file structure. In some cases, the server 340 may be referred to as support side server 340, while the server 345 may be referred to as vendor side server 345. In some examples, the system (e.g., system 100 in FIG. 1) of the present disclosure may comprise the support side server 340, where the support side server 340 may be similar or substantially similar to the server 102 previously described in relation to FIG. 1. The server 340 may comprise one or more modules (not shown for sake of brevity) of server 102. In some embodiments, the support side server 340 may be one or more of logically, electronically, and communicatively coupled to the user device 310-a, shown by communication link 335-c. In some embodiments, the user device 310-a may be associated with a user 305-a, where the user 305-a may also be referred to as a support side user, or simply, support user. The user device 310-a may be used to display an end-user user interface (UI) 325, which may implement one or more aspects of the UIs 700-1000 described below in relation to FIGS. 7-10.

In some cases, the communications network 300 implements one or more aspects of the system 100 and/or communication networks 400-a, and/or 400-b, described in relation to FIGS. 1, 4A, and/or 4B. As shown, the server 340 may be in communication with the user device 310-b (also referred to as client user device) via communication link 335-a. In some cases, the server 340 may be in communication (e.g., indirect) with the vendor side server 345 via communication links 335-c and 335-b. In some other cases, the server 340 may be in direct communication with the vendor side server 345 using a communication link 335-e. In some embodiments, communication link 335-e may be optional (shown as optional by the dashed lines). As shown, the server 345 on the vendor side 323 may also be in communication with client user device 310-b using communication link 335-d. It should be noted that, one or more of the communication links 335 may be bi-directional. Further, the communication links 335 may be wired (e.g., ethernet) or wireless (e.g., Wi-Fi, Bluetooth, cellular, such as 3G/4G/5G, etc.).

The client user device 310-b may comprise a customer data file system (e.g., shown as data file system 469-a in FIG. 4A) and may be used to display a client user interface (UI) 320, where the client UI 320 may be specific to the client/customer data file system, an operating system, and/or enterprise software (e.g., software application, version, patches or fixes, etc.) installed on the user device 310-b. In some examples, the system (e.g., server 340) may enable the support side user 305-a to access (e.g., via a remote connection, a Virtual Private Network (VPN), etc.) the client user device 310-b, for example, to create a data file directory structure on the customer data file system. In one non-limiting example, the user 305-a may gain access by remotely connecting to the client user device 310-b using the end-user UI 325. In such cases, the end-user UI 325 may be used to display a rendition of the client UI 320 on the user device 310-a. In this way, the support side user 305-a may be able to view one or more of: the current directory structure on the customer/client data file system, currently installed software, downloaded but not yet installed software, network settings (e.g., firewall settings) on the client user device 310-b, to name a few non-limiting examples. Further, the support side user 305-a may be able to create a second data file directory structure on the customer data file system, where the second data file directory structure may be similar or substantially similar to the first data file directory structure associated with the data repository 315.

In some other cases, the server 340 may automatically (e.g., without user input or with minimal user input) create the second data file directory structure based on identifying the first data file directory structure for the data file repository 315 within the data file system operated by the data file vendor. For instance, the server 340 may request information pertaining to the first data file directory structure for the data file repository 315 from the vendor side server 345 over communication link 335-e, which may be a bi-directional communication link. The vendor side server 345 may also respond to the request using communication link 335-e, where the response may include directory and sub-directory related data for the first data file directory structure, including a hierarchy (e.g., tree structure) for the folders and/or sub-folders, naming conventions (optional) for the folders, sub-folders, and/or data files, and/or security/access information (e.g., read-only, read-write), to name a few non-limiting examples. Other types of information may be included in the response from the vendor side server 345, in different embodiments. The support side server 340 may analyze the response received from the server 345 to create an identical or substantially identical data file directory structure on the client side 321. In other cases, the server 340 may autonomously scan the first data file directory structure for the data file repository 315 to determine how it has been implemented (e.g., under which folder, sub-folder, etc., data files are stored, how the data files are linked and/or interact with each other, etc.), naming conventions used, and any other relevant information specific to the first data file structure. In some cases, execution of a software program/application may involve a first data file (e.g., data file ‘A’) calling one or more other data files (e.g., data file ‘B’). For instance, data file ‘B’ located within a folder ‘X’ may be called by the software code in data file ‘A’ using the address for data file B's location. In such cases, if the second data file directory structure is not identical or substantially identical to the first data file directory structure, the software program/application may not execute as intended without changes to the code. To alleviate such issues, the system of the present disclosure may facilitate in implementing, on the client side 321, a data file directory structure similar to the one used for the data file repository 315, which may serve to enhance client user experience. FIG. 4A illustrates an example of a communication network 400-a comprising one or more servers (e.g., server 440 on support side 427, server 445 on vendor side 423), one or more user devices (e.g., user device 410-a on support side 427, user device 410-b on client or customer side 421), and a data repository 415 within a data file system operated by the software or data file vendor.

The components on the support side 427, such as the user device 410-a and/or the server 440 may be in communication with the vendor side components (e.g., server 445, data repository 415) over communication link 435-a. Furthermore, the vendor side components may also be in communication with the client-side components (e.g., server 455, user device 410-b) over communication link 435-b. Communication link 435-c may facilitate communications between the user device 410-a and the server 440, and may be similar or substantially similar to the communication link 335-c described in relation to FIG. 3. The communication links 435 (e.g., communication links 435-a, 435-b, 435-c) may be wireless (e.g., Bluetooth, Wi-Fi, cellular communications, such as 3G/4G/5G, etc.) or wired (e.g., ethernet) communication links. In some cases, this data file system may comprise at least of server 445. For instance, the data repository 415 may be hosted or stored on server 445 (also referred to as the vendor side server). In some cases, the servers 440 and 445 may be similar or substantially similar to the servers 340 and 345, respectively, previously described in relation to FIG. 3. Furthermore, the user devices 410-a and 410-b may implement one or more aspects of the user devices 310-a and 310-b, respectively, and vice versa. In some cases, the data repository 415 may also implement one or more aspects of the data repository 315, previously described in relation to FIG. 3, and vice versa. In some cases, the data repository 415 may comprise data related to one or more applications, programs or computer software, etc., provided by the software vendor (e.g., SAP). For instance, the data repository 415 may comprise data related to one or more SAP applications, such as, but not limited to, SAP Hana, NetWeaver (an SAP platform for building business applications), business intelligence software tools provided by SAP, customer relationship management (CRM) tools provided by SAP, etc. It should be noted that, the data repository 415 may comprise data related to additional SAP applications which may not be utilized or licensed by the client. In some cases, a directory structure may refer to the way an operating system arranges files that are accessible to the user. Although not necessary, files are typically displayed in a hierarchical tree structure. For instance, in Windows provided by Microsoft, Inc., of Redmond, Wash., the root directory (i.e., the first or top-most directory in the hierarchy) may be “drive:\”, where “drive” is usually denoted by a letter. For instance, the root directory for an operating system may be “C:\”. In some cases, application or tools related data on the server 445 may be structured in one or more directories. Some non-limiting examples of the types of directories may include physically shared directories, logically shared directories, and local directories. The term “directory structure” may refer to the overall structure and hierarchy of the different directories on the server 445.

In some cases, the system (e.g., system 100 in FIG. 1, server 340 in FIG. 3) of the present disclosure may comprise an end-user UI 425-a, where the end-user UI 425-a may be accessible from the user device 410-a. The end-user UI 425-a may be an example of a graphical user interface and may provide the user 405-a with the selection criteria for one or more applications/programs licensed or utilized by the client (e.g., user 405-b on client side 421). In some cases, the selection criteria may be based on several factors, for instance, the SAP application (e.g., SAP Hana, NetWeaver, etc.). The selection may be obtained from the software vendor's website (e.g., SAP website) listing specific for the client's SAP application listings. Said another way, the support user (e.g., user 405-a) may be able to view from the software vendor's website a listing of the applications/programs that have been purchased or licensed by the client, downloaded and installed, downloaded and not yet installed, etc. For instance, the client may have paid for but not downloaded NetWeaver but may actively be using SAP Hana. The user 405-a may be able to view and access such information from the software vendor's website, so that they can make the appropriate selections for which programs/applications, updates or fixes, patches, etc., need to be downloaded and transferred to the devices (e.g., file server 455, user device 410-b, etc.) on the client side 421. Using that criteria, the user 405-a may select from a menu (e.g., a pull-down menu, shown as operating system menu 952 in FIG. 9) the currently installed operating system on the client side 421 user device 410-b, database product and version (e.g., SAP Hana 2.0, shown as database 954 in FIG. 9) on the user device 410-b, and any other relevant information. After the user 405-a has selected the criteria from the end-user UI 425-a, they may proceed to log into the software vendor's website and navigate through one or more screens to get to the software download section. As shown in FIG. 7, the user 405-a may input a user ID 706 and password 707 specific to the client into a note automation UI 774. The user ID 706 and password 707 may be relayed to the software vendor's website, for instance, by the credential information entering module 114 in FIG. 1. After the software vendor verifies the credential information, the user 405-a may be provided access to the software download section.

In some examples, the end-user UI 425-a may also require the user 405-a to enter the location (i.e., on the user device 410-b) where data from the vendor's website may be downloaded onto the client's hardware. In some cases, the location may be a directory 465-a (e.g., C drive or CA) within a data file system 469-a on the user device 410-b. In some cases, the user 405-a may be able to view (e.g., via a remote connection) the existing directory structure 475-a on the user device 410-b. Further, this location designation (i.e., in directory 465-a) on the client's hardware may allow the system (e.g., system 100) of the present disclosure to create an identical or substantially identical directory structure as the one used by the software vendor. Using the same or similar directory structure as the vendor may allow the client (e.g., user 405-b) to more easily locate the downloaded data in the future on their hardware. Further, the directory structure created (e.g., shown by arrow 476-a) on the user device 410-b may facilitate in ensuring that all the subcomponents of the application, such as the SAP application, are captured in a structured manner. In some cases, the user 405-a may repeat the selection of criteria, indicating the location on the client's hardware where data should be stored, and creating a similar directory structure as the one utilized by the software vendor, for each of the remaining SAP applications and versions the client has in their environment. It should be noted that, the process outlined above may also be used for any uninstalled software that the client has paid for but not downloaded/installed. Further, in some examples, the system (e.g., system 100, server 340) may autonomously or semi-autonomously (i.e., with minimal user input) identify the location on the client user device 410-b for downloading the data files, create an identical or substantially identical directory structure within the data file system 469-a as the one used by the software vendor, etc. That is, the system 100 of the present disclosure may be able to operate with minimal or no user input and may support automating the downloading, transferring, and copying of data files from the data repository 415 to the client user device 410-b.

In some embodiments, the system (e.g., system 100) on the support side 427 may create (e.g., shown by arrow 476-a) the organized second directory structure 475-a within the customer data file system 469-a prior to any data being downloaded. This may allow the system to work through the entire directory tree (e.g., directory structure on server 445 and/or data repository 415 on vendor side 423) based on the selected application (e.g., SAP Hana) so that the directory structure on server 445 is reproduced on the user device 410-b. In some embodiments, the system (e.g., system 100, server 340) may capture the relevant portions of the directory structure on the vendor side 423 in a temporary (i.e., “temp”) file based on which it may update or modify the existing directory structure 475-a on the user device 410-b, further described in relation to the figures below. In some embodiments, for example, when there is a large number of files to transfer, a directory structure may be created for the temp file data. In such a case, the system 100 and/or server 340 will create a directory structure based on the vendor side 423 web site's logical grouping of the vendor side files. The system 100 and/or server 340 would also move the vendor software to the created folders directory. according to some criteria. After updating or modifying the existing directory structure 475-a, the system may start downloading or transferring the application/program data from the vendor side 423 (i.e., from the server 445 and/or the data repository 415) to the user device 410-b. It should be noted that, the data may be directly downloaded and transferred to the user device 410-b, without passing through the support side 427. In other words, the system (e.g., system 100, server 340) may not store any of the data being downloaded from the vendor side 423.

Turning now to FIG. 4B, which illustrates a communication network 400-b, according to an embodiment of the disclosure. Communication network 400-b implements one or more aspects of the communication networks 300 and/or 400-a, previously described in relation to FIGS. 3 and/or 4, respectively. FIG. 4B comprises an example where data from the vendor side (e.g., shown as vendor side 423 in FIG. 4A) has been downloaded from a data repository (e.g., data repository 415 in FIG. 4A) on to the client's hardware, for instance, a user device (e.g., shown as user device 410-b in FIG. 4A) on client side 421-b. A system (e.g., system 100, server 340) on support side 427-b may create and store a log file 477 on the client's data file system 469-b. Client data file system 469-b may be the data file system on the client's hardware and may be similar or substantially similar to the client data file system 469-a previously described in relation to FIG. 4A. In some embodiments, the log file 477 may be created, for instance, prior to or during download, during criteria selection, or when end-user (e.g., user 405-a in FIG. 4A, user 405-c in FIG. 4B) indicates the location within the client data file system 469-b where data (e.g., from the vendor's website) should be downloaded. In some examples, the log file 477 created by the system (i.e., system 100) may comprise a log of steps taken by the computing devices associated with and during the downloading and transferring of data files from the vendor side to the client side. The log file 477 may also include information pertaining to any errors and/or messages (e.g., alerts, notifications, etc.) that occurred during transfer of data files. In this way, the log file 477 may be used to maintain a register or ledger of the steps, errors and/or messages (if any) pertaining to the downloading.

As illustrated, after downloading and transferring of data files, the client data file system 469-b comprises a directory 465-b and the log file 477, where the user directory 465-b is organized according to a directory structure 475-b. In some cases, the directory structure 475-b implements one or more aspects of a directory structure utilized by the vendor. As described above, in some cases, the system (i.e., system 100) may prompt the user 405-c to indicate the location (e.g., shown as data file locations 472-a, 472-b, and 472-c) within the directory 465-b (or the customer data file system 469-b) where the data from the vendor side (e.g., server, data repository, website, etc., associated with the software vendor) should be downloaded and stored. The user 405-c may enter the one or more data file locations 472 from the end-user UI 425-b. In some examples, end-user UI 425-b may be similar or substantially similar to the end-user UI 425-a in FIG. 4A. As shown, one or more data files 470 (e.g., data files 470-a, 470-b, 470-c, 470-d; data files 470-e, 470-f, 470-g; and data file 470-h) may be downloaded to the data file locations 472-a, 472-b, and 472-c.

After the data files 470 have been downloaded and transferred from the vendor's website to the data file locations 472 and organized according to the directory structure 475-b, the downloaded data may be reconciled with the applicable data on the software vendor's website. For instance, the downloaded data files 470 may be compared to the data files on the vendor side (e.g., vendor side 423 in FIG. 4A) to review the data files 470 that were successfully downloaded, data files that were missed or had errors during download, the directory (e.g., directory 465-b) and/or subdirectory (e.g., shown by data file location(s) 472) they were stored in, the directory structure 475-b of the directory and/or sub-directory, etc., to evaluate if the system (i.e., system 100, server 340) captured all the required information/data from the software vendor's website. In some circumstances, during reconciliation, the system may identify one or more anomalies (e.g., one or more data files were missed or not downloaded, one or more data files were only partially downloaded, a data file was downloaded/transferred to the incorrect subdirectory or data file location, etc.) and may automatically (or alternatively, based on input from user 405-c) attempt to rectify the errors (if any) and/or capture the missing information or data from the software vendor, to name two non-limiting examples. In some cases, if there any exceptions that are identified during reconciliation, the system may present these exceptions to the end user 405-c in the form of a text file, for example, or through any other applicable means. The text file may comprise the information pertaining to any anomalies that occurred during downloading and/or exceptions identified during reconciliation, such as, but not limited to, information for one or more data files that were not able to be downloaded. In one such presentation of exceptions, the system may identify within a text (.txt) log file that only 500 notes (both software and pdf files) were downloaded when the user identified a capture of 1000 notes from the vendor website. In such an instance, the log file may identify details of the files that were not downloaded and may also identify why the file was not downloaded. Such details may comprise component, date, time, file name, description of the file, place in the code where the error occurred, stack trace, error description, detailed error description, and error code. Additionally, there are many identifications displaying why a file was not properly download. One such identification is a time-out error, which is provided in the log file when the website does not, for some reason, respond to the download request. After a set amount of time, the system 100 logs this situation as an error and moves on to the next note to download. Time-out errors that may be displayed comprise errors such as, but not limited to, “No PDF button found”, “Unable to click PDF button for note”, “No Download button found. Trying again”, and “Unable to client SNOTE Download button”, to name a few non-limiting examples. These types of error messages may be displayed when the website references a file to download but the referend file is not actually available for download form the website. There are hundreds of other error messages that can be received.

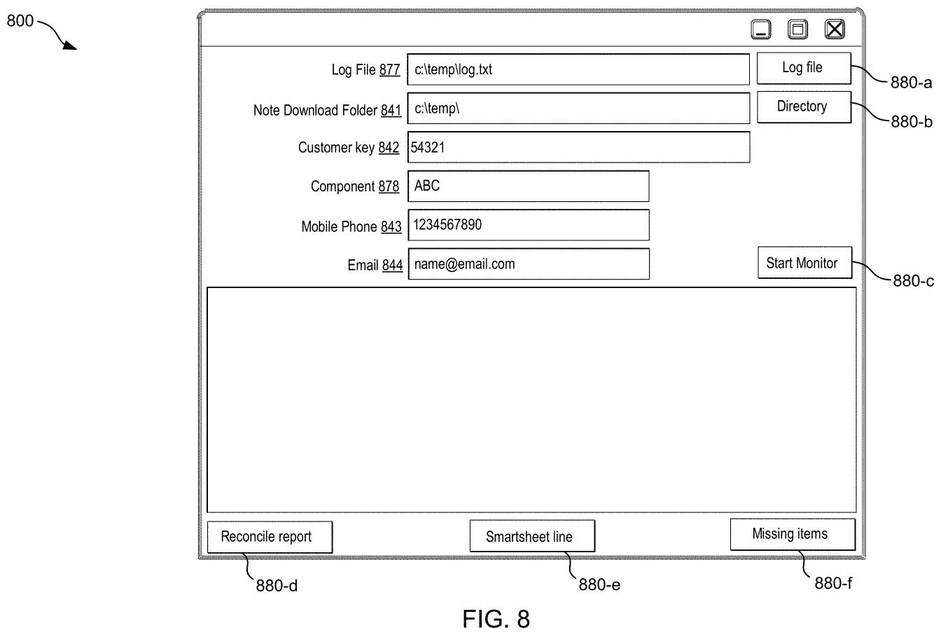

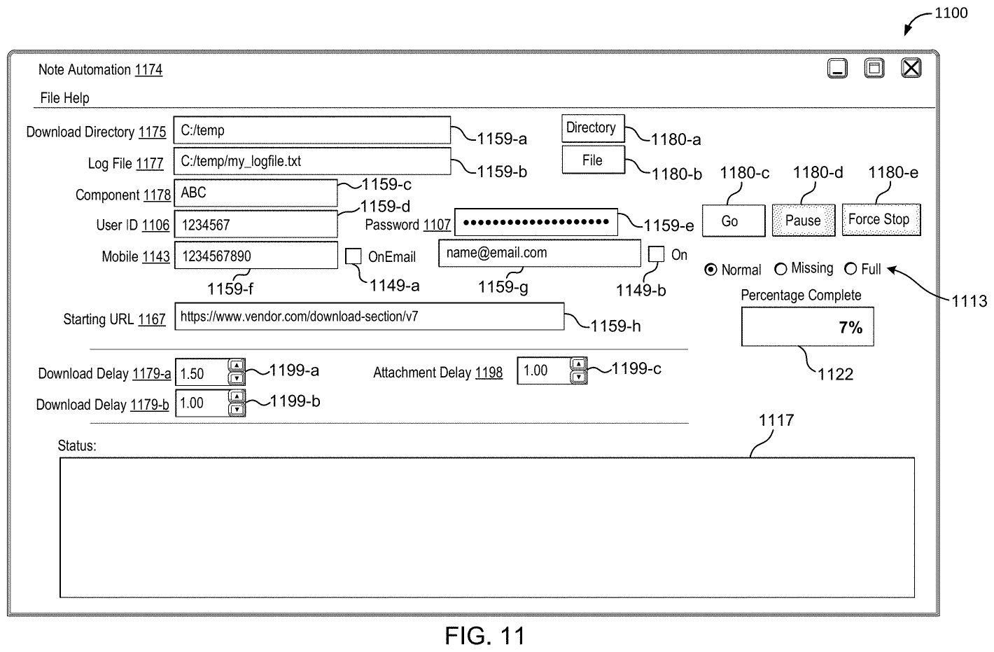

In response to the information in the log file, the user may adjust the program settings prior to re-executing the program. One such adjustment is modifying the speed that the program is operating (e.g., requesting files). Since a failure to properly download a file may be due to a slow website response, a user adjust how long the program waits for a file to begin downloading before identifying a time-out or other error message. This adjustment process may be repeated until all notes are downloaded. Although not necessary, in some cases, the log file 477 may be the text file. In some examples, the system may create one or more reports in text file format (or any other applicable format) for the end user 405-c, such as a completion report, reconcile report, failure or error report, to name a few non-limiting examples. In some cases, the completion report may comprise information for an overall completion rate (e.g., as a percentage or a ratio of data files successfully downloaded to the total number of data files that were scheduled to be downloaded) related to the execution phase. As used herein, the execution phase may comprise at least the downloading and transferring of data files from the vendor to the client. In some examples, the reconcile report may comprise information for one or more data files that need to be reconciled or addressed manually (e.g., user 405-c has to manually download them and transfer them to the client's hardware), while the failure or error report may comprise information related to the ratio of data files that failed to download successfully. Other types of reports are also contemplated in different embodiments, and the examples listed above are not intended to be limiting. In some embodiments, reports may be generated for each application/program (e.g., SAP application) indicated during criteria selection. In some embodiments, one or more of the completion report, reconcile report, and failure or error report may be directly sent to the user device 410-c and may be accessible by the user 405-c from end-user UI 425-b. For example, the end user 405-c may receive one or more reports at an email address (e.g., email 844 in FIG. 8, email address entered in text box 1159-g in FIG. 11) indicated through the end-user UI 425-b. The end-user UI 425-b may implement one or more aspects of the UIs 700-1100, described later in relation to FIGS. 7-11. It should be noted that, the one or more reports may or may not be stored on the user devices, servers, etc., on the client side 421-b.

FIG. 6 illustrates an example of a swim diagram 600 directed to a method for transferring data files, in accordance with one or more implementations. FIG. 6 illustrates a client-side server 655, a user device 610, a support side server 640, a vendor side server 645, and a data repository 615, which may be similar or substantially similar to the client-side server 455, the user device 410-a, the support side server 440, the vendor side server 445, and the data repository 415, respectively, as previously described in relation to FIG. 4A. In some embodiments, one or more additional elements, such as a client user device (e.g., client user device 410-b) may also be utilized. For example, the client-side server 655 may be replaced by a client user device and data files may be downloaded and transferred to the client user device from the vendor side (e.g., the vendor side server 655 and/or the data repository 615). The client-side server 655 may comprise a data file system, such as client data file system 469-a and/or 469-b, described above in relation to FIGS. 4A and/or 4B.

At step 601, a user (e.g., a support side user, an administrator, etc.) may provide a location for saving transferred data files to the support side server 640. Some non-limiting examples of data files may include software files, patches, fixes, etc. As described above, these data files may be transferred (i.e., at step 607) from the vendor side server 645 and/or data repository 615 to the client-side server 655. Additionally, or alternatively, the data files may be transferred from the vendor side to a user device used by a client user.

At step 602, the system (e.g., system 100, support side server 640) or support side user may identify an operating system used by the client. Identification of the operating system may comprise one or more of: remotely connecting to the client-side server or client user device, identifying a current enterprise software utilized by the client, including the operating system it is specific to, etc. In some other cases, the client may have specified the operating system. Other techniques for identifying the operating system are contemplated in different embodiments, and the examples listed above are not intended to be limiting. In some examples, the operating system may be associated with the data files to be downloaded and transferred. As an example, software vendors (e.g., Google from Mountain View, Calif.) provide different versions of the same software (e.g., Google Chrome) for use with different operating systems (e.g., Windows provided by Microsoft Inc., of Redmond, Wash., Mac OS provided by Apple Inc., of Cupertino, Calif., etc.). In a similar fashion, the operating system used by the client may be identified such that only the relevant data files specific to that operating system are downloaded, and data files for other operating systems are ignored.

At step 603, the system (i.e., system 100, support side server 640) or support side user may identify a database 602 and operating system associated with the data files. For example, the system 100, support side server 640, and/or support side user may identify a Windows 10 operating system and Oracle database for SAP software used by the customer/client-side. With such an example, Windows 10 and Oracle software components may be downloaded. If, for example, the client-side systems were running on a Linux OS and with a Sybase database system, the software associated with that configuration would be identified for transfer.

At step 604, the support side user may enter credentials information (e.g., user ID 706, password 707) specific to the client into a credential user interface provided by the data file vendor. The credential user interface may comprise a logon screen (e.g., SAP logon screen) for customers of the data file vendor. In some cases, the data file vendor may be a software vendor, such as SAP. Other types of data file vendors are also contemplated in different embodiments. Some non-limiting examples of credentials information may include a user ID (e.g., shown as user ID 706 in FIG. 7), a password (e.g., password 707 in FIG. 7), and a customer key (e.g., customer key 842 in FIG. 8). It should be noted that, step 604 may be optional (shown as optional by the dashed lines). For instance, in some embodiments, the support side user may have been pre-authorized to initiate download and transfer of data files from the data file vendor to the client user device or file system.

At step 605, the method may comprise navigating to the data file repository 615 on the vendor side. The data file repository 615 may be located within a data file system operated by the data file vendor. It should be noted that, while the vendor side server 645 and the data repository 615 have been shown as different entities, in some cases, the vendor side server 645 may comprise the data repository. For instance, the data file repository may be stored or hosted on the vendor side server 645. In other cases, the vendor side server 645 may be one of logically, communicatively, and electronically linked to the data repository 615. The data repository may be embodied in hardware (e.g., hardware processors, storage media, etc.), software (e.g., a database), or a combination thereof. In some examples, the data file system operated by the software or data file vendor may comprise one or more of the vendor side server 645 and the data repository 615.

At step 606, the support side user (e.g., via the user device 610) and/or the system (i.e., support side server 640) may identify a first data file directory structure for the data file repository 615 within the data file system operated by the data file vendor.

Next, at step 607, the user device 610 may be utilized to create a second data file structure on the client data file system. The client data file system may be hosted or installed on the client-side server 655. In some instances, the client-side server 655 may be a central server located in an environment (e.g., physical office space, third-party data center offering cloud computing services, etc.) used by the client. Alternatively, the client data file system may comprise the client-side server 655. The client data file system may be embodied in hardware, software, or a combination thereof. In some other cases, the client data file system may be hosted or installed on a client user device and may be accessible by a user via a user device. The user may be a client user, or alternatively, a support side user. Further, the user device may be a client user device (e.g., user device 410-b in FIG. 4A), or alternatively, a support side user device (e.g., user device 410-a).

At steps 608 and 609, the method may comprise copying and transferring data files from the first data file directory structure within the data file system operated by the data file vendor to the second data file directory structure in the client data file system (or client-side server 655). For instance, at step 608, the support side user (i.e., via the user device 610) and/or the support side server 640 may instruct the data file repository 615 to copy the data files. Further, at step 609, the data file repository 615 may upload and transfer the relevant data files to the client data file system or the client-side server 655. In some embodiments, the data files may comprise at least one of enterprise application software, patches for the enterprise application software, and support documentation for one or more of the enterprise application software and the patches. Other types of data files are contemplated, and the examples listed above are not intended to be limiting.

In some other cases, the second data file directory (e.g., a data file directory, such as directory 465-b, on the client data file system 469-b that is organized according to the second data file directory structure 475-b) may comprise a temporary second data file folder and a final second data file directory. For instance, FIG. 4B depicts data file locations 472-a and 472-b corresponding to a temporary second data file folder ‘Temp’ and data file location 472-c corresponding to a final second data file directory ‘Final\Programs\’ in the C-drive. Next, the system (e.g., system 100, support side server 640) may copy the data files from the first data file directory structure to the second data file directory structure, where the copying comprises one or more of verifying the second data file directory structure and copying the data files (e.g., data files 470-a-g in FIG. 4B) to the temporary second data file folder. After copying the data files to the temporary second data file folder, the system (e.g., system 100, server 640) may move the data files from the temporary second data file folder to the final second data file directory. For sake of brevity, FIG. 4B only depicts a single data file 470-h in the final second data file directory (i.e., data file location 472-c). It should be noted, however, that the data file location 472-c may comprise one or more of the data files 470-a-g after they have been copied and moved from the temporary data file locations 472-a and 472-b. In some examples, the directory structure for the final second data file directory may be similar or substantially similar to the first data file directory structure for the data file repository 615.

Seen in FIG. 7 is one example of a user interface (UI) 700, according to an embodiment of the disclosure. In this example, the UI 700 comprises a note automation screen 774 (also referred to as note automation window 774) and is related to the information described herein. The note automation screen 774 is an example of a user interface for automating the downloading of legally available software (e.g., data files, as described herein) for a client. The note automation program executables may be installed on a client's machine or server (e.g., user device 410-b, client-side server 455 in FIG. 4) and may use the client's credential information (e.g., client's SAP Online Service System (OSS) IDs) to capture the data files. In some other cases, the note automation program executables may be installed on the support side (e.g., support side 427 in FIG. 4A), for instance, on a user device (e.g., user device 410-a in FIG. 4A) or a server (e.g., server 340 in FIG. 3). In such cases, a support side user (e.g., an administrator) may remotely connect to the client's machine or server to setup a data file directory structure on the client's machine that is similar or substantially similar to a data file directory structure for a data file repository on the vendor side. In some examples, a user device may display the UI 700 comprising the note automation screen 774 when the note automation program is executed on the user device.

In some cases, one or more data files may be downloaded from the data file repository operated by the software vendor to a client data file system. In some embodiments, the data files may be based on, for instance, an SAP system utilized by the client. In one non-limiting example, the note automation program may download SAP OSS notes. Other types of data files may also be downloaded in different embodiments. Some vendors such as SAP may make a distinction in the types of data files. For example, a distinction may be made between software and notes. Data files identified as software may be accessible in a different part of the website and use a different mechanism for downloading as compared to the data files identified as notes. Bug fixes, patches, manuals, and documentation may be identified as notes. computer programs, a database, and a utility application may be designated as software.

It is further contemplated that notes (e.g., SAP OSS notes) may refer to fixes or patches to a variety of issues and components in the software. In some circumstances, such fixes or patches may run into tens of thousands of notes for a client. Attempts to manually download one at a time may take a human operator several months to complete. According to aspects of this disclosure, the note automation program may allow a user (e.g., a support side user) to configure the data files, notes, patches or fixes, software executables, etc., that need to be downloaded on a client's behalf and automate the downloading, copying, and storing of the same to a client's data file system and/or client user device. In some cases, the data files may be directly stored on the client's hardware from the software vendors website.

As shown, the note automation screen 774 may enable a support side user to indicate a download directory 775, where the download directory may refer to the directory or folder where items downloaded from the software vendor's website are stored. In some examples, the support side user may indicate the download directory (e.g., via a textbox 759-a). Additionally, or alternatively, the download directory may be indicated by clicking on a directory button 780-e. Clicking on the directory button 780-a may bring up a file selector window, where the file selector window may display the local storage, including the drives, folders, files, etc., on the client's machine or server. In the example shown, the download directory 775 is a folder named “temp” in the C-drive on the client's user device, data file system, and/or server. Note automation screen 774 also displays another text box 759-b where a user ID 706 may be entered. The user ID 706 may be specific to the client and may comprise an SAP OSS ID, a username, an email address, a cloud-based identity (e.g., user ID associated with Azure Active Directory (AD) provided by Microsoft, Inc., of Redmond, Wash.), or any other applicable unique identifier. In some embodiments, the note automation screen 774 also displays a textbox 759-c for receiving a password 707. As used herein, the term credentials information may refer to a combination of the user ID 706 and the password 707. The user ID 706 and password 707 may enable a user (e.g., client, support side user) to gain access to the software vendor's website. For instance, the software vendor may authenticate a user based on the user ID 706 and password 707, and grant or deny access to the user based on matching the user ID and password to a user profile/entry in an authentication database used by the software vendor. As an example, if the user authentication is successful, the user may be granted access to the downloads section on the software vendor's website. In other cases, if the user ID and password do not match a user profile in the authentication database, the user may be directed to the software vendor's homepage, another website, a password reset page, or a new customer or new accounts page, to name a few non-limiting examples.

As described above, the system (e.g., system 100) of the present disclosure may maintain a log of all steps taken (e.g., during downloading, copying, transferring, etc., of data files), including any errors, alerts, notifications, etc., to a log file. The support side user may indicate a log file 777 directory location using one or more of a text box 759-d and a log file button 780-d. For instance, the support side user may directly type in the directory location (e.g., “temp” folder in C-drive) and the file name (e.g., log.txt) for the log file into the text box 759-d. Additionally or alternatively, a file selector window may be displayed upon the user clicking on the log file button 780-d. The user may navigate through the client data file system and select the directory or data file location where the log file 777 should be stored. In this example, the log file 777 will be stored as a text file named “log.txt” under the “temp” folder in the C-drive on the client's machine. It should be noted that, the download directory and the log file may or may not be stored on the same drive (e.g., C-drive), or even in the same folder (e.g., “temp” folder). In some examples, the log file may be updated in real time and a user may be able to view the log file at any time (e.g., during the download phase). In other cases, the user may need to pause the download, or alternatively, wait until the download completes before viewing the log file 777.

In some examples, the note automation screen 774 may also allow the support side user to enter a component 778, for instance, in a textbox 759-e. One non-limiting example of the component 778 may include an SAP component for which the note automation program is downloading. In some cases, the component 778 text field may be optional. Further, the component 778 text field may be a free text field and may allow the user to enter an easily identifiable/recognizable name for a software component being downloaded by the note automation program. In some cases, a software component (e.g., SAP component) may bundle a set of data packages (e.g., software files, data files, software executables, patches or fixes, etc.) that may be delivered to the client's machine or server as a single unit. For example, the data packages may be distributed disjunctively among software components, which means that the objects (e.g., units of code, instance of a class in Object Oriented Programming (OOP)) in a package may only be delivered to clients with a software component. In some cases, one or more objects may be assigned to a software component by assigning the package (e.g., containing the one or more objects) to the software component. Some non-limiting examples of software components may include SAP components (e.g., SAP BASIS, SAP ABA, SAP HR, SAP APPL, HOME, LOCAL), although other types of software components besides SAP components are also contemplated in different embodiments. In some cases, the user may enter a component name (e.g., Basis Components) into the optional textbox 759-e.

In some embodiments, the note automation program may allow the support side user to indicate one or more download delays 779 (e.g., download delay 779-a, download delay 779-b) using slider bar 787 (e.g., slider bar 787-a, slider bar 787-b) displayed on the note automation screen 774. Some non-limiting example of download delays may include a PDF download delay and a SAR/CAR download delay. The download delays 779 may comprise an amount of time (e.g., in seconds, minutes, etc.) that the note automation program waits to start a PDF download process, a SAR/CAR download process, etc. In some circumstances, the download delays 779 may help create a buffer between files, which may allow for time if the software vendor's website is responding slowly and/or if the download of a previous file is delayed, to name two non-limiting examples. It should be noted that, the indication of download delays 779 is optional. In some examples, the note automation program may also allow a user to indicate ‘0’ seconds for the download delay 779.

As seen, the note automation screen 774 also displays one or more buttons 780 (e.g., start button 780-a, log button 780-b, configuration button 780-c). Clicking or pressing on the start button 780-a may cause the note automation program to start the automation of downloading, copying, and/or transferring data files from the software vendor's website or data repository (e.g., shown as data file repository 415 in FIG. 4A) to the client/customer data file system. For instance, after the support side user clicks on the start button 780-a, the note automation program may redirect the user to a logon screen for the software vendor's website, such as an SAP logon screen. In some cases, redirecting the user may comprise opening a web browser (e.g., Google Chrome provided by Alphabet, Inc., of Mountain View, Calif.) and displaying the SAP logon screen in the web browser. The note automation program may autofill the user ID 706 and password 707 entered by the user in the note automation screen into the respective fields in the SAP logon screen and complete the login. Alternatively, for instance, if the user ID and password were not entered into the note automation screen 774, the user may log into the software vendor's website (e.g., SAP website) using the client supplied credentials information (e.g., OSS ID and/or password).

As noted above, in some embodiments, the log file 777 may be updated in real time and may be accessed by the user anytime during and/or after the execution phase. The execution phase may refer to the phase after the start button 780-a has been clicked and the automation of downloading, copying, transferring, and/or reconciling of data files has begun. In some examples, clicking the log button 780-b may bring up a log viewer and/or the log file. The log viewer may allow the support side user to view the details of each activity the note automation program is performing or has performed. One such log viewer may comprise a pop-up window providing a near real-time display of the system processing steps. For example, the percentage complete informs a user us how much of the expected download is completed. In other cases, clicking the log button 780-b may open up the most recent version of the log file 777. For instance, the note automation program may periodically update the log file 777 every second, 5 seconds, 10 seconds, 1 minute, etc., and the user may view the last version of the log file 777 to see all the activities that have been logged by the note automation program. The note automation screen 774 may also display a configuration button 780-c, which may be used to open a configuration file. The configuration file may comprise information pertaining to the criteria used to setup the automated download, the criteria based on the received user input (e.g., from textboxes 759, sliders 787, etc.). The note automation screen 774 also includes an optional simulation mode. As seen, the note automation screen 774 may present a simulation mode 781 checkbox. If the simulation mode 781 checkbox is clicked, the note automation program may allow the user to indicate one or more simulation failure rates (e.g., simulation failure rate 782-a, simulation failure rate 782-b). The simulation failure rates may be indicated on a scale (e.g., between 0 to 100) using slider bars 787 (e.g., slider bar 787-c, slider bar 787-d). Some non-limiting examples of simulation failure rates may include a PDF simulation failure rate (e.g., the probability of failure for PDFs) and a SAR/CAR simulation failure rate (e.g., the probability of failure for SAR/CAR). Although not necessary, the simulation failure rates may be used, primarily, for development and testing purposes. In some embodiments, the simulation failure rates may or may not be used by the end user (i.e., support side user) during execution of the program. In some cases, the simulation mode 781 may be used for testing and no files may be downloaded. Instead, the simulation mode may allow the downloading to be simulated. Use of the simulation mode 781 may facilitate testing of the reconciler and may be optional (i.e., for the end user) during execution of the note automation program.

FIG. 8 illustrates another UI 800, according to an embodiment of the disclosure. The UI 800 may be an example of a UI for a note automation reconciler program. In some cases, UI 800 implements one or more aspects of the UIs described herein, including at least UI 700. The note automation reconciler program may use the log file (e.g., log file 777) generated by the note automation program to check the data files that were downloaded to those identified in the log file. In some cases, any exceptions that are found, such as missing data files, partially downloaded files, corrupted data files, etc., may be display to the end user to address. In some aspects, the results presented by the note automation reconciler program may allow the end user to rerun the note automation program to capture the missing information (e.g., data files), or if necessary, manually download one or more files individually without the note automation program through the software vendor's website. The UI 800 may be displayed on a user device (e.g., user device 410-a in FIG. 4A), where the user device may be on the support side (e.g., support side 427 in FIG. 4A). As shown, the UI 800 displays a data file location for a log file 877, where the log file 877 is created on the client's machine or server. Further, the UI 800 displays one or more buttons 880 (e.g., log file button 880-a, directory button 880-b), and a data file location for a note download folder 841. Clicking on the log file button 880-a and directory button 880-b may cause the system (e.g., system 100) to bring up file selector window(s) where the log file and the downloaded items are respectively stored. It should be noted that the log file and/or the downloaded items may or may not be stored on the support side (e.g., support side 427). For example, in some embodiments, the log file and the downloaded items may only be stored on the client's machine (e.g., user device 410-b) and/or a server on the client side (e.g., server 455 on client side 421). The UI 800 may also comprise one or more text fields for a customer key 842 (e.g., a key that uniquely identifies the customer or client, may be numeric, alphanumeric, or a string), a component 878 (e.g., a SAP component for which the program associated with UI 800 is reconciling, maybe similar or substantially similar to the component 778 in FIG. 7), a mobile phone number 843 (e.g., so that the note automation reconciler program can text the user of any issues), and/or an email address 844 (e.g., so that the note automation reconciler program or the system, such as system 100, can email the user of any issues) to name a few non-limiting examples. The mobile phone number 843 and/or the email address 844 may be the phone number and email address, respectively, of the person or user executing the note automation reconciler program. In some embodiments, one or more of the text fields (e.g., mobile phone 843 text field, component 878 text field) may be optional. Alternatively, one or more additional text fields (e.g., for an alternate email address or phone number) may be displayed in UI 800. In some examples, the customer key 842 text field may be a free text field and may be used to help manage the client's software archive using a unique identifier (e.g., 54321). Further, the component 878 may be a free text field and may be used to focus on one or more of the components (e.g., SAP components, such as SAP BASIS, SAP ABA, SAP HR, SAP APPL, HOME, LOCAL, etc.) that were completed in the note automation program, described above in relation to FIG. 7.

In some examples, the UI 800 also displays a start monitor button 880-c (e.g., for starting the reconciler), a reconcile report button 880-d (e.g., for viewing an up-to-date report of reconciliation so far), an optional smartsheet line button 880-e, and a missing items button 880-f (e.g., for viewing items that were to be downloaded but were not). One or more additional buttons may also be displayed in the UI 800 in different embodiments.

Turning now to FIG. 9, which displays a UI 900 for a software automation program. The software automation program may be used to capture software components (e.g., SAP components) for the client based on one or more criteria (e.g., operator(s) 951, operating system 952, and/or database 954, to name a few non-limiting examples).

In some circumstances, the software a client maybe entitled to, may consist of hundreds of thousands of individual files or notes. The process to capture all of those manually would take several months or longer to complete. According to aspects of this disclosure, the software automation program (also referred to as the note software automation program) allows the user to set one or more criteria for their application (e.g., enterprise software application) through the UI 900. The software automation program may be installed and run on the client's machine or server. Alternatively, the software automation program may be installed and run on the support side (e.g., server 340, user device 310-a in FIG. 3). In some embodiments, the software automation program may utilize a web browser to interface with the software vendor's website.

As seen, UI 900 may display a software automation assistant window 960 comprising one or more data fields (e.g., directory 965 for software, temporary folder 966 for software, start from link 967, operator(s) 951, operating system 952, database 954, etc.). Further, the software automation assistant window 960 may display one or more buttons 968 (e.g., browse directory button 968-a, browse directory button 968-b), one or more checkboxes (e.g., no data download 949 checkbox), and/or run button 964. In some examples, the software automation program may allow a user (e.g., a support user, an administrator, etc.) to enter a web address or URL (e.g., https://www.vendor.com/download-section/v7) into textbox 959-c, the textbox corresponding to start from link 967. Additionally, or alternatively, the user may click on browse directory button 968-a to select the directory or folder where downloaded items are stored. Upon clicking the browse directory button 968-a, the software automation program may bring up a file selector window, which may be an example of a UI that allows the user to navigate through the data file system on the client's machine or server. As shown, the directory or folder (e.g., subfolder “output” in folder “temp” within C-drive) may be displayed in textbox 959-a in UI 900. Similarly, upon clicking the browse directory button 968-b, the software automation program may bring up the same (or another) file selector window and allow the user to select the folder where the downloaded files (e.g., software executables, patches or fixes, data files, etc.) are temporarily stored. It should be noted that both the directory 965 for software and temporary folder 966 for software may be located on the client's machine or server (i.e., not on the support side server or user device). In some embodiments, the data files downloaded and stored in the temporary folder 966 (e.g., “temp” folder in C-drive, shown in textbox 959-b) may be moved (e.g., copied and transferred) to another folder on the client's machine or server. For example, the data files may be moved to the “output” subfolder within the “temp” folder, shown in textbox 959-a. In other cases, the data files may be moved to another drive (e.g., D-drive), or another folder in the C-drive. In some cases, the software automation program, another program (e.g., software movement program), or a module of the system (e.g., system 100) may assist in copying and moving the downloaded data files from the temporary folder to another folder on the client's machine or server. In some embodiments, the another folder where the downloaded data files are moved may match the directory 965 for software shown in textbox 959-a, which may serve to ease management of the downloaded data files.

In some cases, the support side user may input a web address, URL, or another applicable network location in textbox 959-c associated with start from link 967. In some aspects, this may allow the client and/or support side user to focus on a particular application, component, software version, etc., within the software vendor's website. For example, the user may input the link (https://www.vendor.com/download-section/v7) for indicating that the download should only pertain to version 7 (or v7) of the software. This eliminates version(s) prior to and greater than 7 (e.g., version 6, version 8, etc.). In some cases, selecting the no data download checkbox (i.e., checkbox 949) may be used to indicate that the software automation program should refrain from downloading any data (e.g., software files). In such cases, the software automation program may create the file or directory structure, perform another pre-defined task, or prompt the user to select a task, to name three non-limiting examples. In some aspects, the no data download feature may enable the software automation program to quickly create all or at least a portion of the directory structure on the client's hardware without trying to download the data at the same time. In some examples, the operators 951 (e.g., operator 951-a, operator 951-b) may be optional, and may be Boolean type operators for matching options. As shown, the end user (e.g., support side user) may select the operator(s) 951 using a drop-down menu. Some non-limiting examples of Boolean type operators include: I/O, True/False, and Yes/No. Other types of operator(s) 951 besides Boolean, are contemplated in different embodiments. Further, the operator 951 may be selected by other means than a drop-down menu. For instance, in some cases, the user may input a value (e.g., 1) into a textbox. In another case, the user may select a checkbox or a radio button to indicate the operator 951. The software automation assistant window 960 may also allow the end user to select operating system 952, which may be the operating system installed on the client side (e.g., user device and/or server on client side). The operating system may be based on the hardware installed or utilized on the client side. Some non-limiting examples of operating system 952 may include Windows, Mac OS, Linux, and Android. Other types of operating systems known in the art may be supported in different embodiments. In some instances, indication of the operating system 952, for instance, via a drop-down menu or through other means, may enable the software automation program to only focus on downloading the files specific to that operating system and ignore files for other operating systems. Such a design may optimize the time required for the download process. Database 954 may refer to a target database for download. One non-limiting example of a target databases may comprise an Oracle database system. In some embodiments, the software automation program may focus on the target database selected by the user through the software automation assistant window 960 and may not focus on the other databases. The software automation assistant window 960 also displays a run button 964. Clicking the run button 964 starts the execution of the software automation program based on the one or more parameters or criteria indicated by the user through the UI 900, where the parameters or criteria comprise one or more of the directory 965 for software, temporary folder 966 for software, start from link 967 (optional), operators 951 (optional), operating system 952, database 954, and no data download 954 checkbox.

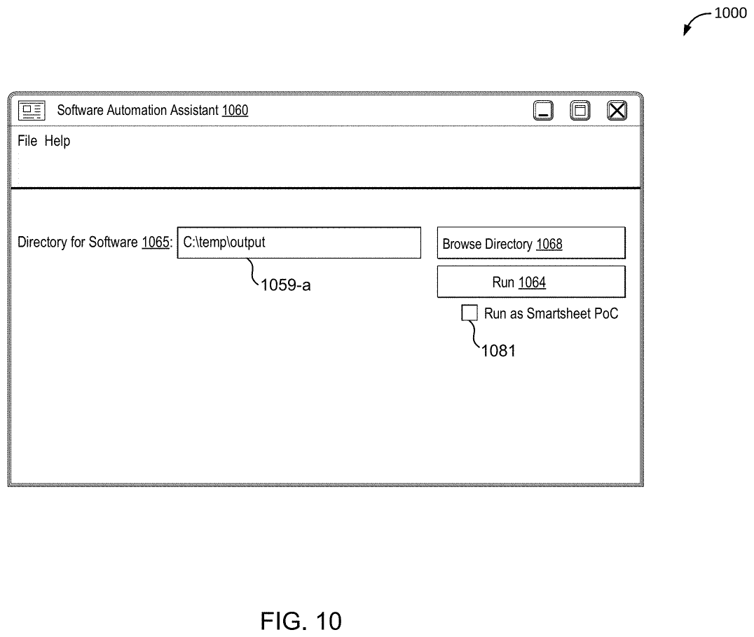

FIG. 10 illustrates a UI 1000, where the UI 1000 displays a software automation assistant window 1060 for a software movement program, according to an embodiment of the disclosure. In some cases, UI 1000 implements one or more aspects of any of the other UIs described herein. As shown, software automation assistant window 1060 allows an end user (e.g., a support side user, such as user 410-a in FIG. 4) to indicate a directory 1065 for software through an input text field 1059-a. The input text field 1059-a may be similar or substantially similar to the input text field 959-a in FIG. 9. Additionally, or alternatively, the end user may click on browse directory button 1068 to open a file selector window. The file selector window may be an example of a UI that allows the user to navigate through the data file system, including directories, sub-directories, folders, etc., on the client's machine or server. In some examples, the file selector window may display a pull-down menu for selection of the file location. After navigating through the data file system on the client's machine or server, the user may select the directory location (e.g., subfolder “output” in folder “temp” on the C-drive). The directory location may then be displayed in the input text field 959-a. The directory 1065 for software may refer to the directory location (or folder) where at least a portion of the downloaded items (e.g., data files, software executables, patches or fixes to the software, support documentation for software, etc.) are to be moved. As noted above, in some cases, the downloaded items may initially be stored in a temporary folder and then moved to another directory location (e.g., one or more other folders), for instance, based on the log file(s) (e.g., log file 477 shown in FIG. 4B) generated during the directory structure creation part of the program. The software automation assistant window 1060 may also display a run button 1064, where the run button 1064 implements one or more aspects of the run button 964 in FIG. 9. For instance, clicking on the run button 1064 may cause the software movement program to begin moving the downloaded items from the temporary folder to the other directory location on the client's machine or server (e.g., user device 410-b, client-side server 455 in FIG. 4A). The software automation assistant window 1060 also includes an optional checkbox 1081, which allows the user to run the software movement program in smartsheet Proof of Concept (PoC) mode. The smart sheet proof of concept enables updating of a smartsheet in real-time about the process of the file transfer. The smart sheet is different than the log viewer in that the smart sheet is decoupled from the program (i.e., the smart sheet is a website and the log viewer is built into the system 100) and may be utilized for system management, by, for example, identifying the various operations of each system instance.

FIG. 11 illustrates an example of a UI 1100, where the UI 1100 displays a note automation screen 1174, according to an alternate embodiment of the disclosure. Note automation screen 1174 may implement one or more aspects of the note automation screen 774, previously described in relation to FIG. 7. The note automation screen 1174 is an example of a user interface for automating the downloading of legally available software (e.g., data files, as described herein) for a client. The note automation program executables may be installed on a client's machine or server (e.g., user device 410-b, client-side server 455 in FIG. 4) and may use the client's credential information (e.g., client's SAP Online Service System (OSS) IDs) to capture the data files. In some other cases, the note automation program executables may be installed on the support side (e.g., support side 427 in FIG. 4A), for instance, on a user device (e.g., user device 410-a in FIG. 4A) or a server (e.g., server 340 in FIG. 3. In such cases, a support side user (e.g., an administrator) may remotely connect to the client's machine or server to setup a data file structure on the client's machine that is similar or substantially similar to a data file structure for a data file repository (e.g., data repository 415 in FIG. 4A) on the vendor side (e.g., vendor side 423 in FIG. 4A). In some examples, a user device may display the UI 1100 comprising the note automation screen 1174 when the note automation program is executed on the user device. Further, in some cases, the data files may be downloaded based on, for instance, the client SAP systems. In one embodiment, the note automation program downloads SAP OSS notes, although other types of data files may be downloaded in different embodiments. As used herein, notes (e.g., SAP OSS notes) may refer to fixes or patches to a variety of issues and components in the software. In some circumstances, such fixes or patches may run into tens of thousands of notes for a client. Attempts to manually download one at a time may take a human operator several months to complete. According to aspects of this disclosure, the note automation program may allow a user (e.g., a support side user) to configure the data files, notes, patches or fixes, software executables, etc., that need to be downloaded on a client's behalf and automate the downloading, copying, and storing of the same to a client's data file system and/or client user device. In some cases, the data files may be stored on the client's hardware directly from the software vendors website.

As shown, the note automation screen 1174 may enable a support side user to indicate a download directory 1175, where the download directory may refer to the directory or folder where items downloaded from the software vendor's website are stored. In some examples, the support side user may indicate the download directory (e.g., via a textbox 1159-a). Additionally, or alternatively, the download directory may be indicated by clicking on a directory button 1180-e. Clicking on the directory button 1180-a may bring up a file selector window, where the file selector window may display the local storage, including the drives, folders, files, etc., on the client's machine or server. In the example shown, the download directory 1175 is a folder named “temp” in the C-drive on the client's user device. Note automation screen 1174 also displays a textbox 1159-b that may be used to display the directory location where log file 1177 may be stored. As described above, the system (e.g., system 100) of the present disclosure may maintain a log of all steps taken (e.g., during downloading, copying, transferring, etc., data files), including any errors, alerts, notifications, etc., to a log file, where the log file is stored on the client side (e.g., a user device or server utilized, owned, and/or operated by the client). For instance, in the example shown, the log file 1177 may be stored as a text file having the name “my_logfile.txt” in the “temp” folder on the C-drive. In some embodiments, the note automation program may allow the user to directly type in the directory location for storing the log file 1177 into text box 1159-b (e.g., without having to click on the file button 1180-b and opening the file selector window). It should be noted that, the download directory 1175 and the log file 1177 may or may not be stored on the same drive (e.g., C-drive), or even in the same folder (e.g., “temp” folder). In some examples, the log file 1177 may be updated in real time and a user may be able to view the log file at any time (e.g., during the download phase). In other cases, the user may need to pause the download, or alternatively, wait until the download completes before viewing the log file 1177.

Note automation screen 1174 also displays one or more other text boxes 1159, such as, but not limited to, a text box 1159-c (e.g., for entering a component 1178), a text box 1159-d (e.g., for entering a user ID 1106), a text box 1159-d (e.g., for entering a password 1107), a text box 1159-e (e.g., for entering a mobile number 1143), and a textbox 1159-f (e.g., for entering an email address). As used herein, the term credentials information may refer to a combination of the user ID 1106 and the password 1107. Furthermore, as described above, the user ID 1106 entered in textbox 1159-d may be specific to the client and may comprise an SAP OSS ID, a username, an email address, a cloud-based identity (e.g., user ID associated with Azure Active Directory (AD) provided by Microsoft, Inc., of Redmond, Wash.), or any other applicable unique user identifier. The user ID 1106 and password 1107 may enable a user (e.g., client, support side user) to gain access to the software vendor's website. For instance, the software vendor may authenticate a user based on the user ID 1106 and password 1107, and grant or deny access to the user based on matching the user ID and password to a user profile/entry in an authentication database used by the data file or software vendor. If the user authentication is successful, the user may be granted access to the downloads section on the software vendor's website. In other cases, if the user ID and password do not match a user profile in the authentication database, the user may be directed to the software vendor's homepage, another website, a password reset page, or a new customer or new accounts page, to name a few non-limiting examples. In some examples, the note automation screen 774 may also allow the support side user to enter the component 1178 in textbox 1159-c. One non-limiting example of the component 1178 may include an SAP component for which the note automation program is downloading. In some cases, the component 1178 text field may be optional. Further, the component 1178 text field may be a free text field (e.g., can accept any character or combination of characters with minimal or no restrictions) and may allow the user to enter an easily identifiable/recognizable name for a software component being downloaded by the note automation program. In some cases, a software component (e.g., SAP component) may bundle a set of data packages (e.g., software files, data files, software executables, patches or fixes, etc.) that may be delivered to the client's machine or server as a single unit. For example, the data packages may be distributed disjunctively among software components, which means that the objects (e.g., units of code, instance of a class in Object Oriented Programming (OOP)) in a package may only be delivered to clients with a software component. In some cases, one or more objects may be assigned to a software component by assigning the package (e.g., containing the one or more objects) to a software component. Some non-limiting examples of software components may include SAP components (e.g., SAP BASIS, SAP ABA, SAP HR, SAP APPL, HOME, LOCAL), although other types of software components besides SAP components are also contemplated in different embodiments. In some cases, the user may enter a component name (e.g., Basis Components, ABC, etc.) into the optional textbox 1159-c.

In some embodiments, the note automation program may allow the support side user to indicate one or more delays (e.g., download delay 1179-a, download delay 1179-b, attachment delay 1198) using dropdown menus 1199 (e.g., dropdown menu 1199-a, dropdown menu 1199-b, dropdown menu 1199-c) displayed on the note automation screen 1174. Some non-limiting example of download delays 1179 may include a PDF download delay and a SAR/CAR download delay. The download delays 1179 may comprise an amount of time (e.g., in seconds, minutes, etc.) that the note automation program waits to start a PDF download process, a SAR/CAR download process, etc. In some circumstances, the download delays 1179 may help create a buffer between files, which may allow for time if the software vendor's website is responding slowly and/or if the download of a previous file is delayed, to name two non-limiting examples. It should be noted that, the indication of download delays 1179 is optional. For instance, in some examples, the note automation program may also allow a user to indicate ‘0’ seconds for the download delay 1179. In some examples, the attachment delay 1198 may be entered via dropdown menu 1199-c, although other means (e.g., a slider bar, a text box, etc.) for entering the attachment delay are contemplated in different embodiments. In some circumstances, the one or more delays, including, but not limited to, the download delays 1179 and/or the attachment delay 1198 may help overcome the limitations of the parallel nature and heavily AJAX dependent architecture of the software vendor's website (e.g., SAP website).

As seen, the note automation screen 1174 also displays one or more buttons 1180 (e.g., ‘Go’ button 1180-c, ‘Pause’ button 1180-d, ‘Force Stop’ button 1180-e). Clicking or pressing on the ‘Go’ button 1180-c may cause the note automation program to start the automation of downloading, copying, and/or transferring data files from the software vendor's website or data repository (e.g., shown as data file repository 415 in FIG. 4A) to the client's machine or server. For instance, after the support side user clicks on the button 1180-c, the note automation program may redirect the user to a logon screen for the software vendor's website, such as an SAP logon screen. In some cases, redirecting the user may comprise opening a web browser (e.g., Google Chrome provided by Alphabet, Inc., of Mountain View, Calif.) and displaying the SAP logon screen in the web browser. Although not necessary, in some instances, the note automation program may autofill the user ID 1106 and password 1107 entered by the user in the note automation screen 1174 into the respective fields in the SAP logon screen and complete the login. Alternatively, for instance, if the user ID and password were not entered into the note automation screen 1174, the user may log into the software vendor's website (e.g., SAP website) using the client supplied credentials information (e.g., user ID 1106, which may be an OSS ID, and/or password 1107).

As noted above, in some embodiments, the log file 1177 may be updated in real time and may be accessed by the user anytime during and/or after the execution phase. The execution phase may refer to the phase after the start or ‘Go’ button 1180-a has been clicked and the automation of downloading, copying, transferring, and/or reconciling of data files has begun. In some examples, the note automation screen 774 may additionally display a log button (e.g., shown as log button 780-b in FIG. 7), which may be used to open a log viewer and/or the log file. The log viewer may allow the support side user to view the details of each activity the note automation program is performing or has performed. In other cases, clicking the log button may open the most recent version of the log file 1177. For instance, the note automation program may periodically update the log file 1177 every second, 5 seconds, 10 seconds, 1 minute, etc., and the user may view the last saved version of the log file 1177 to see all the activities that have been logged by the note automation program until that point in time.

In some examples, the software automation program may allow a user (e.g., a support user, an administrator, etc.) to enter a web address or URL (e.g., https://www.vendor.com/download-section/v7) into textbox 1159-h, which may be an example of a input textbox for indicating a starting URL 1167. For instance, the support side user may input a web address, URL, or another applicable network location in textbox 1159-h, which may serve as an alternate way to indicate from where the items (e.g., data files) for the automation process should be downloaded. In some aspects, the starting URL 1167 may also allow the client and/or support side user to focus on a particular application, component, software version, etc., within the software vendor's website. For example, the user may input starting URL 1167 (https://www.vendor.com/download-section/v7) for indicating that the download should only pertain to version 7 (or v7) of the software. The note automation program then eliminates downloading version(s) prior to and greater than 7 (e.g., version 6, version 8, etc.), for instance.

In some cases, the note automation screen 1174 also displays a percentage complete 1122 (e.g., 7%), which serves as an indicator about the progress of the program. Further, the note automation screen 1174 also allows a user to select a mode 1113 (e.g., normal, missing, or full) through one or more radio buttons. In other cases, the user may select the mode 1113 through a dropdown menu, a text box, a check box, or through any other applicable means. In some instances, when the normal mode is selected, the note automation program may perform a single run and attempt to download all the data files. At the end of the run, the note automation program may generate and display a report of its progress, where the report may be displayed in the note automation screen 1174, another window in the UI 900, an email, a text message (e.g., SMS), or through any other applicable means. In some examples, when the normal mode is run, the note automation program may not attempt to restart the download process (e.g., as a second run) based on one or more missing downloads.

In some cases, the end user may select the missing mode radio button. In such cases, after selecting the ‘Go’ button 1180-c, the note automation program may run but only attempt to download the one or more data files that were missed, for instance, after running the program in the normal mode. Lastly, in the full mode, the program may implement one or more aspects of the normal mode and the missing mode. For example, after running the note automation program in the full mode, the program may restart itself (i.e., if it determines that one or more data files, such as notes, are missing). If no notes or data files are missing, the note automation program may produce a report of its progress, similar to the normal mode. Additionally, or alternatively, the note automation program may also adjust its download speed to optimize the percentage or ratio of data files that are successfully downloaded, for instance, at the end of the first run. In this way, the number of downloads that are missed and need to be reattempted in subsequent runs may also be minimized.

As illustrated, the note automation screen 1174 may comprise an optional status window 1117, which may be used to provide the end user with real time information about the status of the note automation program. Some non-limiting examples of status information that may be displayed in the status window 1117 may include a list of data files (e.g., software executables, notes, etc.) that are currently downloading, successfully downloaded, and/or missed. Other examples of status information include a list of data files that were partially downloaded and/or were corrupted (i.e., had errors), and status information for the software vendor's website, servers (e.g., vendor side server 445 in FIG. 4A), and/or data repository (e.g., data repository 415 in FIG. 4A), to name a few non-limiting examples. As seen, the UI 1100 may also comprise one or more checkboxes 1149 (e.g., ‘OnEmail’ checkbox 1149-a, ‘On’ checkbox 1149-b). The checkboxes 1149, if checked, will turn on the ability to either send an email to the user about the programs progress, send a text about the programs progress, or both.

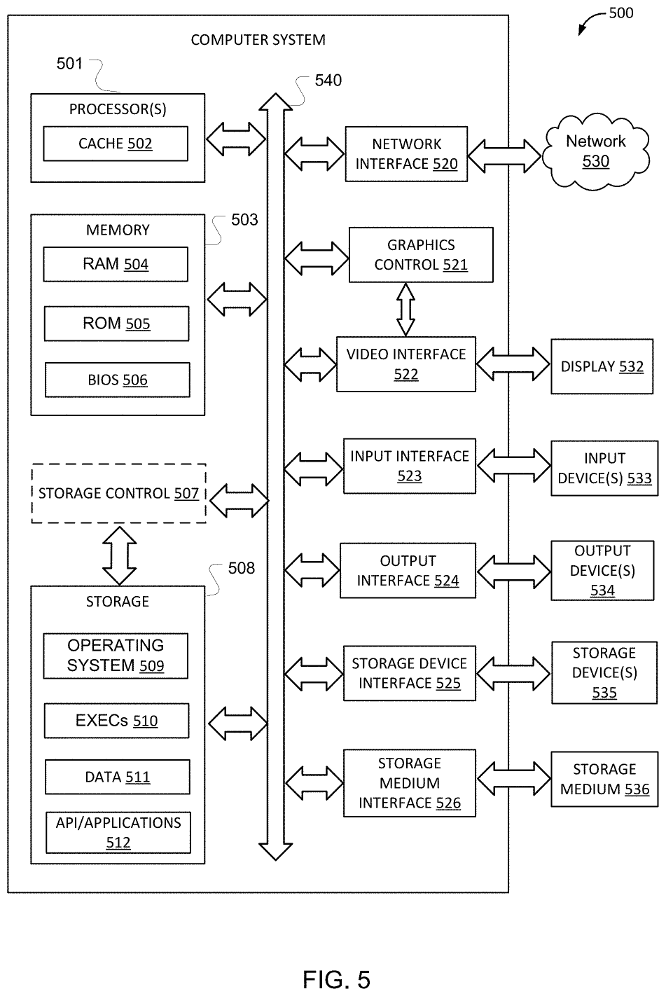

FIG. 5 illustrates a diagrammatic representation of one embodiment of a computer system 500, within which a set of instructions can execute for causing a device to perform or execute any one or more of the aspects and/or methodologies of the present disclosure. The components in FIG. 5 are examples only and do not limit the scope of use or functionality of any hardware, software, firmware, embedded logic component, or a combination of two or more such components implementing particular embodiments of this disclosure. Some or all of the illustrated components can be part of the computer system 500. For instance, the computer system 500 can be a general-purpose computer (e.g., a laptop computer) or an embedded logic device (e.g., an FPGA), to name just two non-limiting examples.

Moreover, the components may be realized by hardware, firmware, software or a combination thereof. Those of ordinary skill in the art in view of this disclosure will recognize that if implemented in software or firmware, the depicted functional components may be implemented with processor-executable code that is stored in a non-transitory, processor-readable medium such as non-volatile memory. In addition, those of ordinary skill in the art will recognize that hardware such as field programmable gate arrays (FPGAs) may be utilized to implement one or more of the constructs depicted herein.

Computer system 500 includes at least a processor 501 such as a central processing unit (CPU) or a graphics processing unit (GPU) to name two non-limiting examples. Any of the subsystems described throughout this disclosure could embody the processor 501. The computer system 500 may also comprise a memory 503 and a storage 508, both communicating with each other, and with other components, via a bus 540. The bus 540 may also link a display 532, one or more input devices 533 (which may, for example, include a keypad, a keyboard, a mouse, a stylus, etc.), one or more output devices 534, one or more storage devices 535, and various non-transitory, tangible computer-readable storage media 536 with each other and/or with one or more of the processor 501, the memory 503, and the storage 508. All of these elements may interface directly or via one or more interfaces or adaptors to the bus 540. For instance, the various non-transitory, tangible computer-readable storage media 536 can interface with the bus 540 via storage medium interface 526. Computer system 500 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 501 (or central processing unit(s) (CPU(s))) optionally contains a cache memory unit 532 for temporary local storage of instructions, data, or computer addresses. Processor(s) 501 are configured to assist in execution of computer-readable instructions stored on at least one non-transitory, tangible computer-readable storage medium. Computer system 500 may provide functionality as a result of the processor(s) 501 executing software embodied in one or more non-transitory, tangible computer-readable storage media, such as memory 503, storage 508, storage devices 535, and/or storage medium 536 (e.g., read only memory (ROM)). Memory 503 may read the software from one or more other non-transitory, tangible computer-readable storage media (such as mass storage device(s) 535, 536) or from one or more other sources through a suitable interface, such as network interface 520. Any of the subsystems herein disclosed could include a network interface such as the network interface 520. The software may cause processor(s) 501 to carry out one or more processes or one or more steps of one or more processes described or illustrated herein. Carrying out such processes or steps may include defining data structures stored in memory 503 and modifying the data structures as directed by the software. In some embodiments, an FPGA can store instructions for carrying out functionality as described in this disclosure. In other embodiments, firmware includes instructions for carrying out functionality as described in this disclosure.

The memory 503 may include various components (e.g., non-transitory, tangible computer-readable storage media) including, but not limited to, a random-access memory component (e.g., RAM 504) (e.g., a static RAM “SRAM”, a dynamic RAM “DRAM, etc.), a read-only component (e.g., ROM 505), and any combinations thereof. ROM 505 may act to communicate data and instructions unidirectionally to processor(s) 501, and RAM 504 may act to communicate data and instructions bidirectionally with processor(s) 501. ROM 505 and RAM 504 may include any suitable non-transitory, tangible computer-readable storage media. In some instances, ROM 505 and RAM 504 include non-transitory, tangible computer-readable storage media for carrying out a method. In one example, a basic input/output system 506 (BIOS), including basic routines that help to transfer information between elements within computer system 500, such as during start-up, may be stored in the memory 503.

Fixed storage 508 is connected bi-directionally to processor(s) 501, optionally through storage control unit 507. Fixed storage 508 provides additional data storage capacity and may also include any suitable non-transitory, tangible computer-readable media described herein. Storage 508 may be used to store operating system 509, EXECs 510 (executables), data 511, API applications 512 (application programs), and the like. Often, although not always, storage 508 is a secondary storage medium (such as a hard disk) that is slower than primary storage (e.g., memory 503). Storage 508 can also include an optical disk drive, a solid-state memory device (e.g., flash-based systems), or a combination of any of the above. Information in storage 508 may, in appropriate cases, be incorporated as virtual memory in memory 503.

In one example, storage device(s) 535 may be removably interfaced with computer system 500 (e.g., via an external port connector (not shown)) via a storage device interface 525. Particularly, storage device(s) 535 and an associated machine-readable medium may provide nonvolatile and/or volatile storage of machine-readable instructions, data structures, program modules, and/or other data for the computer system 500. In one example, software may reside, completely or partially, within a machine-readable medium on storage device(s) 535. In another example, software may reside, completely or partially, within processor(s) 501.

Bus 540 connects a wide variety of subsystems. Herein, reference to a bus may encompass one or more digital signal lines serving a common function, where appropriate. Bus 540 may be any of several types of bus structures including, but not limited to, a memory bus, a memory controller, a peripheral bus, a local bus, and any combinations thereof, using any of a variety of bus architectures. As an example, and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 500 may also include an input device 533. In one example, a user of computer system 500 may enter commands and/or other information into computer system 500 via input device(s) 533. Examples of an input device(s) 533 include, but are not limited to, an alpha-numeric input device (e.g., a keyboard), a pointing device (e.g., a mouse or touchpad), a touchpad, a touch screen and/or a stylus in combination with a touch screen, a joystick, a gamepad, an audio input device (e.g., a microphone, a voice response system, etc.), an optical scanner, a video or still image capture device (e.g., a camera), and any combinations thereof. Input device(s) 533 may be interfaced to bus 540 via any of a variety of input interfaces 523 (e.g., input interface 523) including, but not limited to, serial, parallel, game port, USB, FIREWIRE, THUNDERBOLT, or any combination of the above.

In particular embodiments, when computer system 500 is connected to network 530, computer system 500 may communicate with other devices, such as mobile devices and enterprise systems, connected to network 530. Communications to and from computer system 500 may be sent through network interface 520. For example, network interface 520 may receive incoming communications (such as requests or responses from other devices) in the form of one or more packets (such as Internet Protocol (IP) packets) from network 530, and computer system 500 may store the incoming communications in memory 503 for processing. Computer system 500 may similarly store outgoing communications (such as requests or responses to other devices) in the form of one or more packets in memory 503 and communicated to network 530 from network interface 520. Processor(s) 501 may access these communication packets stored in memory 503 for processing.

Examples of the network interface 520 include, but are not limited to, a network interface card, a modem, and any combination thereof. Examples of a network 530 or network segment 530 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 530, may employ a wired and/or a wireless mode of communication. In general, any network topology may be used.

Information and data can be displayed through a display 532. Examples of a display 532 include, but are not limited to, a liquid crystal display (LCD), an organic liquid crystal display (OLED), a cathode ray tube (CRT), a plasma display, and any combinations thereof. The display 532 can interface to the processor(s) 501, memory 503, and fixed storage 508, as well as other devices, such as input device(s) 533, via the bus 540. The display 532 is linked to the bus 540 via a video interface 522, and transport of data between the display 532 and the bus 540 can be controlled via the graphics control 521.

In addition to a display 532, computer system 500 may include one or more other peripheral output devices 534 including, but not limited to, an audio speaker, a printer, a check or receipt printer, and any combinations thereof. Such peripheral output devices may be connected to the bus 540 via an output interface 524. Examples of an output interface 524 include, but are not limited to, a serial port, a parallel connection, a USB port, a FIREWIRE port, a THUNDERBOLT port, and any combinations thereof.

In addition, or as an alternative, computer system 500 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a non-transitory, tangible computer-readable medium may encompass a circuit (such as an IC) storing software for execution, a circuit embodying logic for execution, or both, where appropriate. The present disclosure encompasses any suitable combination of hardware, software, or both.

Those of skill in the art will understand that information and signals may be represented using any of a variety of different technologies and techniques. Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, a software module implemented as digital logic devices, or in a combination of these. A software module may reside in RAM memory, flash memory, ROM memory, EPROM memory, EEPROM memory, registers, hard disk, a removable disk, a CD-ROM, or any other form of non-transitory, tangible computer-readable storage medium known in the art. An exemplary non-transitory, tangible computer-readable storage medium is coupled to the processor such that the processor can read information from, and write information to, the non-transitory, tangible computer-readable storage medium. In the alternative, the non-transitory, tangible computer-readable storage medium may be integral to the processor. The processor and the non-transitory, tangible computer-readable storage medium may reside in an ASIC. The ASIC may reside in a user terminal. In the alternative, the processor and the non-transitory, tangible computer-readable storage medium may reside as discrete components in a user terminal. In some embodiments, a software module may be implemented as digital logic components such as those in an FPGA once programmed with the software module.

It is contemplated that one or more of the components or subcomponents described in relation to the computer system 500 shown in FIG. 5 such as, but not limited to, the network 530, processor 501, memory, 503, etc., may comprise a cloud computing system. In one such system, front-end systems such as input devices 533 may provide information to back-end platforms such as servers (e.g., computer systems 500) and storage (e.g., memory 503). Software (i.e., middleware) may enable interaction between the front-end and back-end systems, with the back-end system providing services and online network storage to multiple front-end clients. For example, a software-as-a-service (SAAS) model may implement such a cloud-computing system. In such a system, users may operate software located on back-end servers through the use of a front-end software application such as, but not limited to, a web browser.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured for transferring data files, the system comprising:
one or more hardware processors configured by machine-readable instructions to:
provide a location for saving transferred data files;
identify an operating system associated with the data files;
identify a database system associated with the data files;
enter credential information into a credential user interface provided by a data file vendor;
navigate to a data file repository within a data file system operated by the data file vendor;
identify a first data file directory structure for the data file repository within the data file system operated by the data file vendor;
create a second data file directory structure on a customer data file system; and
copy the data files from the first data file directory structure within the data file system operated by the data file vendor to the second data file directory structure in the customer data file system.

2. The system of claim 1,
wherein the data files comprise at least one of enterprise application software, patches for the enterprise application software, and support documentation for the enterprise application software and the patches;
wherein the data files are related to one or more operating systems;
wherein the first data file directory structure comprises a link identifying a group of files;
wherein the group of files comprises files related to at least one of a particular application and a particular version of the data files;
wherein the second data file directory structure comprises a temporary second data file folder and a final second data file directory; and
wherein copying the data files from the first data file directory structure to the second data file directory structure comprises one of verifying the second data file directory structure and copying the data files to the temporary second data file folder and moving the data files from the temporary second data file folder to the final second data file directory after copying the data files to the temporary second data file folder.

3. The system of claim 1,
wherein the one or more hardware processors are further configured by machine-readable instructions to identify one or more delay times for copying at least one data file type before entering credential information into a credential user interface provided by the data file vendor;
wherein copying the data files from the first data file directory structure within the data file system operated by the data file vendor to the second data file directory structure in the customer data file system comprises,
identifying one or more of the at least one data file type, and
delaying a request to copy the one or more of the at least one data file type by one of the one or more delay times; and
wherein the at least one data file type comprises a Portable Document Format (PDF) and a SAR/CAR file type.

4. The system of claim 1, wherein the one or more hardware processors are further configured by machine-readable instructions to:
create a log file, wherein the log file comprises one or more of information received from the user, requests sent to the data file vender, response messages received from the data file vendor, and error messages, wherein at least one of the response messages comprises names of the data files;
create a configuration file, wherein the configuration file comprises criteria for copying the data files from the first data file directory structure to the second data file directory structure;
utilize the log file and second data file directory structure to verify the second data file directory includes information related to one or more data files not downloaded to the second data file directory structure; and one of,
re-copy one or more data files from the first data file directory structure within the data file system operated by the data file vendor to the second data file directory structure in the customer data file system, wherein the re-copying of the one or more data files comprises copying the one or more data files not downloaded to the second data file directory structure, and
manually download to the second data file directory structure the one or more data files not downloaded to the second data file directory structure.

5. The system of claim 4, wherein the information received from the user comprises the location for saving transferred data files, the data file operating system type, and the database system associated with the transferred data files.

6. The system of claim 4, wherein utilizing the log file and second data file directory structure to verify the second data file directory comprises information related to one or more data files not downloaded to the second data file directory structure comprises providing a customer key, enterprise component, and customer contact information;
wherein the customer key, enterprise component, and customer contact information are utilized to identify a customer, an enterprise component type, and the customer respectively;
wherein utilizing the log file and second data file directory structure to verify the second data file directory structure includes each of the names of the data files comprises,
simulating a failure rate prior to copying the data files from the first data file directory structure to the second data file directory structure, and
simulating the copying of the data files from the first data file directory structure to the second data file directory structure to determine that one or more data files are not downloaded to the second data file directory structure; and
wherein the failure rate comprises a probability of a copying failure for at least one of a Portable Document Format (PDF) file type and a SAR/CAR file type.

7. A method of transferring data files, comprising:
providing a location for saving transferred data files;
identifying a data file operating system type;
identifying a database system associated with the transferred data files;
entering credential information into a credential user interface provided by a data file vendor;
navigating to a data file repository within a data file system operated by the data file vendor;
identifying a first data file directory structure for the data file repository within the data file system operated by the data file vendor;
creating a second data file directory structure on a customer data file system; and
copying the data files from the first data file directory structure within the data file system operated by the data file vendor to the second data file directory structure in the customer data file system.

8. The method of claim 7, wherein the data files comprise at least one of enterprise application software, patches for the enterprise application software, and support documentation for the enterprise application software and patches for an operating system related to the customer data file system;
wherein the first data file directory structure comprises a link identifying a group of files;
wherein the group of files comprises one of a particular application and a particular version of the data files;
wherein the second data file directory structure comprises a temporary second data file folder and a final second data file directory; and
wherein copying the data files from the first data file directory structure to the second data file directory structure comprises one of verifying accuracy of the second data file directory structure and copying the data files to the temporary second data file folder and moving the data files from the temporary second data file folder to the final second data file directory.

9. The method of claim 7, further comprising identifying one or more delay times for copying at least one data file type before entering credential information into a credential user interface provided by a data file vendor, and wherein copying the data files from the first data file directory structure within the data file system operated by the data file vendor to the second data file directory structure in the customer data file system comprises;
identifying one or more of the at least one data file type; and
delaying a request to copy the one or more of the at least one data file type by one of the one or more delay times; and
wherein the at least one data file type comprises a Portable Document Format (PDF) and a SAR/CAR file type.

10. The method of claim 7, further comprising:
creating a log file before entering credential information into a credential user interface provided by a data file vendor, wherein the log file comprises one or more of information received from the user, requests sent to the data file vender, response messages received from the data file vendor, wherein at least one of the response messages comprises names of the data files, and error messages;
creating a configuration file, wherein the configuration file comprises criteria for copying the data files from the first data file directory structure to the second data file directory structure;
utilizing the log file and second data file directory structure to verify the second data file directory comprises including each of the names of the data files and displaying names of one or more data files not downloaded to the second data file directory structure;
re-copying the data files from the first data file directory structure within the data file system operated by the data file vendor to the second data file directory structure in the customer data file system, wherein the re-copying of the data files comprises copying the one or more data files not downloaded to the second data file directory structure; and
manually downloading, to the second data file directory structure, the one or more data files not downloaded to the second data file directory structure.

11. The method of claim 10, wherein the information received from the user at least comprises the location for saving transferred data files, the data file operating system type, and the database system associated with the transferred data files.

12. The method of claim 10, wherein utilizing the log file and second data file directory structure to verify the second data file directory includes each of the names of the data files further comprises:
providing a customer key, an enterprise component, and customer contact information, wherein the customer key, enterprise component, and customer contact information are utilized to identify a customer, an enterprise component type, and the customer respectively;
simulating a failure rate prior to copying the data files from the first data file directory structure to the second data file directory structure, wherein the failure rate comprises a probability of a copying failure for at least one of a Portable Document Format (PDF) file type and a SAR/CAR file type; and
simulating the copying of the data files from the first data file directory structure to the second data file directory structure to determine whether the log file and the second data file directory structure may be used to verify the second data file directory structure includes each of the names of the data files and display the names of one or more data files not downloaded to the second data file directory structure.

13. A non-transient computer-readable storage medium having instructions embodied thereon, the instructions being executable by one or more processors to perform a method for transferring data files, the method comprising:
providing a location for saving transferred data files;
identifying a data file operating system type;
identifying a database system associated with the transferred data files;
entering credential information into a credential user interface provided by a data file vendor;
navigating to a data file repository within a data file system operated by the data file vendor;
identifying a first data file directory structure for the data file repository within the data file system operated by the data file vendor;
creating a second data file directory structure on a customer data file system; and
copying the data files from the first data file directory structure within the data file system operated by the data file vendor to the second data file directory structure in the customer data file system.

14. The computer-readable storage medium of claim 13, wherein the data files comprise at least one of enterprise application software, patches for the enterprise application software, and support documentation for the enterprise application software and patches for an operating system related to the customer data file system;
wherein the first data file directory structure comprises a link identifying a group of files;
wherein the group of files comprises one of a particular application and a particular version of the data files;
wherein the second data file directory structure comprises a temporary second data file folder and a final second data file directory; and
wherein copying the data files from the first data file directory structure to the second data file directory structure comprises one of verifying accuracy of the second data file directory structure and copying the data files to the temporary second data file folder and moving the data files from the temporary second data file folder to the final second data file directory.

15. The computer-readable storage medium of claim 13, wherein the method further comprises identifying one or more delay times for copying at least one data file type before entering credential information into a credential user interface provided by a data file vendor, and wherein copying the data files from the first data file directory structure within the data file system operated by the data file vendor to the second data file directory structure in the customer data file system comprises;
identifying one or more of the at least one data file type; and
delaying a request to copy the one or more of the at least one data file type by one of the one or more delay times; and
wherein the at least one data file type comprises a Portable Document Format (PDF) and an SAR/car file type.

16. The computer-readable storage medium of claim 13, wherein the method further comprises:
creating a log file before entering credential information into a credential user interface provided by a data file vendor, wherein the log file comprises one or more of information received from the user, requests sent to the data file vender, and response messages received from the data file vendor, wherein at least one of the response messages comprises names of the data files, and error messages;
creating a configuration file, wherein the configuration file comprises criteria for copying the data files from the first data file directory structure to the second data file directory structure;
utilizing the log file and second data file directory structure to verify the second data file directory structure includes each of the names of the data files and displaying the names of one or more data files not downloaded to the second data file directory structure;
re-copying the data files from the first data file directory structure within the data file system operated by the data file vendor to the second data file directory structure in the customer data file system, wherein the re-copying of the data files comprises copying the one or more data files not downloaded to the second data file directory structure; and
manually downloading, to the second data file directory structure, the one or more data files not downloaded to the second data file directory structure.

17. The computer-readable storage medium of claim 16, wherein the information received from the user at least comprises the location for saving transferred data files, the data file operating system type, and the database system associated with the transferred data files.

18. The computer-readable storage medium of claim 16, wherein utilizing the log file and second data file directory structure to verify the second data file directory structure includes each of the names of the data files further comprises:
providing a customer key, enterprise component, and customer contact information, wherein the customer key, enterprise component, and customer contact information are utilized to identify a customer, an enterprise component type, and the customer respectively;
wherein utilizing the log file and second data file directory structure to verify the second data file directory includes each of the names of the data files further comprises: simulating a failure rate prior to copying the data files from the first data file directory structure to the second data file directory structure, wherein the failure rate comprises a probability of a copying failure for at least one of a Portable Document Format (PDF) file type and a SAR/CAR file type; and
wherein utilizing the log file and second data file directory structure to verify the second data file directory includes each of the names of the data files further comprises: simulating the copying of the data files from the first data file directory structure to the second data file directory structure to determine whether the log file and the second data file directory structure may be used to verify the second data file directory includes each of the names of the data files and display the names of one or more data files not downloaded to the second data file directory structure.
